(19) United States
(12) Patent Application Publication
(10) Pub. No.: US 2012/0029145 A1
(43) Pub. Date: Feb. 2, 2012

(54) EXTRUSION OF POLYURETHANE COMPOSITE MATERIALS

(76) Inventor: Wade H. Brown, Mooresville, NC (US)

(21) Appl. No.: 13/010,646

(22) Filed: Jan. 20, 2011

Related U.S. Application Data
(63) Continuation-in-part of application No. 12/473,138, filed on May 27, 2009, now abandoned.
(60) Provisional application No. 61/056,184, filed on May 27, 2008.
(60) Provisional application No. 61/296,522, filed on Jan. 20, 2010.
(60) Provisional application No. 61/391,988, filed on Oct. 11, 2010.

(51) Int. Cl. C08L 75/04; B29C 45/18

(52) U.S. Cl. 524/590; 264/328.18

(57) ABSTRACT

A polyurethane composite material is described herein. The composite material may comprise a product of a reaction mixture between two or more polyols and an isocyanate, and may contain high levels of inorganic particulate material. Methods of preparing the composite material by forcing the material through a hole are also described. These composite materials may be useful in products such as synthetic building materials.

### CROSS-REFERENCE TO RELATED APPLICATIONS

This application is a continuation in part of U.S. patent application Ser. No. 12/473,138, filed on May 27, 2009, which claims the benefit of U.S. Provisional Application No. 61/056,184, filed May 27, 2008. This application also claims the benefit of U.S. Provisional Application No. 61/296,522, filed Jan. 20, 2010 and U.S. Provisional Patent Application No. 61/391,988, filed Oct. 11, 2010. All of the above priority documents are hereby incorporated by reference in their entireties.

### BACKGROUND

1. Field

Some embodiments include foamed and nonfoamed polymeric material, such as highly filled polyurethane composite materials, methods of forming and extruding the same, and articles including the same. The composite compositions may have matrices of polymer networks and dispersed phases of particulate and/or fibrous materials, which may have excellent mechanical properties, and may render them suitable for use in load bearing applications, such as in building materials. The composites may be stable to weathering, may be molded and colored to desired functional and aesthetic characteristics, and may be environmentally friendly, since they may make use of recycled particulate or fibrous materials as the dispersed phase.

Some embodiments may include methods and systems for imparting desired shape, including three-dimensional shapes, and surface characteristics to a moldable or pliable material as the material cures or hardens. It may be applicable to the shaping and embossing of thermosetting resin systems during curing, and may be used to form these resin systems into a variety of products, including synthetic lumber, roofing, and siding.

2. Description of the Related Art

Polymeric composite materials that contain organic or inorganic filler materials have become desirable for a variety of uses because of their excellent mechanical properties, weathering stability, and environmental friendliness.

These materials can be relatively low density, due to their foaming, or high density when unfoamed, but are extremely strong, due to the reinforcing particles or fibers used throughout. Their polymer content also gives them good toughness (i.e., resistance to brittle fracture), and good resistance to degradation from weathering when they are exposed to the environment. This combination of properties renders some polymeric composite materials very desirable for use in building materials, such as roofing materials, decorative or architectural products, outdoor products, insulation panels, and the like.

### SUMMARY

Some embodiments include a composite material that may comprise: 1) a product of a reaction of a mixture that may comprise a diisocyanate or polyisocyanate and a polyol, and/or 2) an inorganic particulate material. Two or more polyols may be included in the reaction mixture. For example, the reaction mixture may comprise a first polyol that may have a hydroxyl number from about 300 mg KOH/g to about 500 mgKOH/g; and a second polyol that may have a hydroxyl number from about 150 mg KOH/g to about 300 mg KOH/g. The inorganic particulate material may be dispersed throughout the product of the reaction mixture and/or may have a weight that may be about 60% to about 85% of the weight of the composite material. Furthermore, the composite material may have a shape provided by a process comprising forcing the inorganic particulate material dispersed in the reaction mixture through a hole.

Some embodiments include a method of preparing a composite polyurethane material comprising: reacting a mixture comprising a diisocyanate or polyisocyanate and a polyol and blending a product of a reaction of the mixture with an inorganic particulate material. Two or more polyols may be included in the reaction mixture. For example, the reaction mixture may comprise a first polyol that may have a hydroxyl number greater from about 300 mg KOH/g to about 1000 mg KOH/g and a second polyol that may have a hydroxyl number from about 150 mg KOH/g to about 300 mg KOH/g. When the product of the reaction of the mixture is blended with an inorganic particulate material, the blending may provide a substantially uniform mixture. Furthermore, the substantially uniform mixture may be forced through a hole into a mold without heating and the mixture may be cured in the mold.

Some embodiments include a composite material comprising: a product of a reaction of a mixture comprising: a diisocyanate or polyisocyanate; a first polyol having a hydroxyl number from about 300 mg KOH/g to about 500 mg KOH/g; and a second polyol having a hydroxyl number from about 150 mg KOH/g to about 300 mg KOH/g; and an inorganic particulate material that is dispersed throughout the product of the reaction mixture, wherein the inorganic particulate material has a weight that is about 60% to about 85% of the weight of the composite material and; wherein the composite material has a shape provided by a process comprising forcing the inorganic particulate material dispersed in the reaction mixture through a hole.

Some embodiments include a method of preparing a composite polyurethane material comprising: reacting a mixture comprising: a diisocyanate or polyisocyanate; a first polyol having a hydroxyl number greater from about 300 mg KOH/g to about 1000 mg KOH/g; a second polyol having a hydroxyl number from about 150 mg KOH/g to about 300 mg KOH/g; blending a product of a reaction of the mixture with an inorganic particulate material to provide a substantially uniform mixture; without heating, forcing the substantially uniform mixture through a hole into a mold; and curing the mixture in the mold.

Some embodiments include a method of preparing a synthetic building material comprising: reacting a mixture comprising: a diisocyanate or polyisocyanate; a first polyol having a hydroxyl group number from about 300 mg KOH to about 1000 mg KOH; a second polyol having a hydroxyl group number from about 150 mg KOH to about 300 mg KOH; wherein the ratio of the first polyol to the second polyol is about 3 to about 20; and wherein the reaction mixture has a viscosity of about 1 cP to about 1500 cP; water at a concentration of about 0.02% to about 2% of the weight of the composite material; blending a product of the reaction mixture with an inorganic particulate material to provide a substantially uniform mixture; wherein the filler has a weight that is about 60% to about 85% of the weight of the composite material; without heating, forcing the substantially uniform mixture through a hole into a mold; and curing the mixture in the mold.

### BRIEF DESCRIPTION OF THE DRAWINGS

FIG. 1 is an illustration of an extruder including a screw shaft with various screw elements.

FIG. 2 is a drawing of a kneading block element.

FIG. 3 is an view of lobal screw elements in a twin screw extruder.

FIG. 4 is an illustration of one configuration of an extruder containing multiple segments useful in the production of polyurethane composite materials.

FIG. 5 is an illustration of one configuration of an extruder containing conveying and mixing section useful in the production of polyurethane composite materials.

FIG. 6 is an illustration of another configuration of an extruder containing conveying and mixing sections useful in the production of polyurethane composite materials.

FIG. 7A is a top plan view, FIG. 7B is a side plan view, and FIG. 7C is an end plan view of some embodiments.

FIG. 8 is a partially expanded isometric view of one end of the system illustrated in FIG. 1.

FIG. 9A is an end plan view of some embodiments of the system. FIG. 9B is an exploded sectional view of the system of FIG. 9A.

FIG. 10 is a sectional view of a profile mold belt used in some embodiments of the system of the invention.

FIG. 11 is a partial sectional, partial end plan view of a four belt configuration of an embodiment of a system.

FIG. 12 is a sectional view of a configuration of the system of the invention using drive belts and supporting the sides of the mold belts with pressurized air.

FIG. 13 is an elevated side view of an embodiment of a continuous forming apparatus.

FIG. 14 is a cross sectional view of the continuous forming apparatus of FIG. 1 along line 2-2.

FIG. 15 is an alternative exploded cross sectional view of a cleat of a first plurality of cleats, a cleat of a second plurality of cleats, a first endless belt, and a second endless belt that may be used with the continuous forming apparatus of FIG. 13 taken along line 2-2.

FIG. 16 is a view of the first endless mold belt surface of FIG. 15 along line 4-4 as supported by a first plurality of cleats.

FIG. 17 is an elevated side view of another embodiment of a continuous forming apparatus.

FIG. 18 is a cross sectional view of the continuous forming apparatus of FIG. 17 along line 6-6.

FIG. 19 is an elevated side view of an alternative embodiment of a continuous forming apparatus.

FIG. 20 is a top view of the continuous forming apparatus of FIG. 19.

FIG. 21 is a cross sectional view of the continuous forming apparatus of FIG. 19 along line 9-9.

FIG. 22 is an alternative cross sectional view of a cleat of a first plurality of cleats, a cleat of a second plurality of cleats, a first endless belt, a second endless belt, a third endless belt, and a fourth endless belt that may be used with the continuous forming apparatus of FIG. 19 taken along line 9-9.

FIG. 23 is a cross sectional view of the first endless mold belt surface, a cleat of a first plurality of cleats, a second endless belt, and a third endless belt of FIG. 22 along line 11-11.

FIG. 24 is an elevated side view of an alternative embodiment of a continuous forming apparatus.

FIG. 25 is a top view of the continuous forming apparatus of FIG. 24.

FIG. 26 is a cross sectional view of the continuous forming apparatus of FIG. 24 along line 14-14.

FIG. 27 is an elevated side view of another embodiment of a continuous forming apparatus.

FIG. 28 is a cross sectional view of the mold belt of FIG. 27 along line 16-16.

FIG. 29 is a top view of the cross sectional view of FIG. 28 along line 17-17.

FIG. 30 is an exploded view of an embodiment of a cleat.

### DETAILED DESCRIPTION

It has been found that a highly filled, foamed or unfoamed composite polymeric material having good mechanical properties may be obtained with relatively few components. This may result in a substantial decrease in cost, which may be due to decreased materials cost and/or decreased complexity of the process chemistry. The may help to reduce capital investment in process equipment.

Described herein are polymeric composite materials and extrusion processes related to such materials. More particularly, the extrusion processes may be related to polyurethane composite materials. In some embodiments, highly filled polyurethane composite materials may be extruded. The polymeric composite materials may contain some amount of filler content. In particular embodiments a polymeric composite material may include a polyurethane formed by reaction of a reaction mixture comprising one or more monomeric or oligomeric poly- or di-isocyanates; and at least one polyol. In preferred embodiments the one or more monomeric or oligomeric poly- or di-isocyanates may include an MDI. In some embodiments, at least one polyol may be selected from a plant-based polyol or an oil based polyol. Suitable polyols may include polyester polyols, polyether polyols, polycarbonate polyols, polyacrylic polyols, and others described herein. More than one polyol may be used in accordance with some embodiments. The polymeric composite materials may contain some amount of filler content. Such materials may then be shaped and formed into solid surface articles. Articles comprising the polyurethane composite material as described herein may be suitable for structure, building, and outdoor applications.

In some embodiments, the composite material may additionally include an inorganic filler. In some embodiments, the inorganic filler may include coal ash such as fly ash or bottom ash or mixtures of fly and bottom ash. In some embodiments, the polyurethane composite material may comprise about 40-85% inorganic filler. In other embodiments, the polyurethane composite material may comprise about 65-75% inorganic filler. In some embodiments, the polyurethane composite material may comprise about 60-85% inorganic filler.

In some embodiments, the polyurethane composite material may additionally include chain extenders, cross linkers, or combinations thereof. In some embodiments, the polyurethane composite material includes a chain extender. In some embodiments, the chain extender may include ethylene glycol, glycerin, 1,4-butane diol, trimethylolpropane, glycerol, sorbitol, or combinations thereof. In some embodiments, the chain extender may be an amine chain extender, for example a diamine. In some embodiments, the polyurethane composite material may include glycol extenders. In some embodiments, the chain extender may be an organic compound having two or more hydroxyl groups.

In some embodiments, the polyurethane composite material may be in the form of a shaped article. In some embodiments, the shaped article may include roofing material, siding material, carpet backing, synthetic lumber, building panels, scaffolding, cast molded products, decking material, fencing material, marine lumber, doors, door parts, moldings sills, stone, masonry, brick products, post signs, guard rails, retaining walls, park benches, tables slats, and/or railroad ties. A solid surface article may include a portion, wherein the portion includes at least some of the polyurethane composite material as described herein.

In some embodiments, the polyurethane composite material may include fibrous materials. Fibrous materials may be in a variety of forms and may be incorporated into the composite materials in a variety of arrangements. For example, in some embodiments the fibrous material may be chopped fibers such as chopped fiberglass or chopped basalt fiber. A polyurethane composite material may also include axially oriented fiber rovings disposed on, in, or beneath the surface of the composite.

The aforementioned components may be reacted in accordance with certain techniques and other additives. For example, the polyurethane composite material may be mixed and reacted in an extruder. In some embodiments, a method of forming a polyurethane composite material may include providing at least one polyol, providing at least one poly or di-isocyanate, providing an inorganic filler; and extruding the at least one polyol, the at least one poly or di-isocyanate, and the inorganic filler, into an extruded mixture. Additives such as chain extenders and coupling agents may be extruded or otherwise included in the reaction mixture. The method may further include placing the extruded mixture in a mold and/or shaping the extruded mixture may be shaped in a mold. In some embodiments, the mold may be formed by one or more belts of a forming device.

In some embodiments, there may be advantages of mixing the at least one polyol with a solvent. For example, it has been discovered that treatment or mixing with a solvent may result in thicker and harder skin of the formed composite material. Any suitable solvent may be used including an organic solvent such as pentane, hexane, carbon tetrachloride, trichloroethylene, methylene chloride, chloroform, methyl chloroform, perchloroethylene, and ethyl acetate. In some embodiments, about 2 to about 10 weight percent of the solvent may be added to one or more components prior to mixing and/or extruding.

In some embodiments, a method of forming a polyurethane composite material may include providing at least one polyol, providing at least one poly or di-isocyanate, providing about 40 to about 85 weight percent of an inorganic filler, providing excess blowing agent; extruding the at least one polyol, the at least one poly or di-isocyanate, the inorganic filler, and the excess blowing agent into an extruded, foaming mixture, and containing the extruded mixture in a mold. In some embodiments, the composite mixture may include about 60 to about 85 weight percent of the inorganic filler. In some embodiments, the composite mixture may include about 65 to about 80 weight percent of the inorganic filler. The inorganic filler may include many different types of filler. One preferred filler includes fly ash. In some embodiments, the mold may sufficiently restrain the foaming mixture to provide a desired shape or density to the composite material. In some embodiment, restraining such foaming composite material may result in higher strength and stiffness of the composite material. This may result from the alteration of cell size and cell structure.

In some embodiments, a method of coating a solid surface article may include depositing the polyurethane composite material as described herein on a solid surface article, shaping the polyurethane composite material on the solid surface article in a mold; and curing the polyurethane composite material on the solid surface article.

In some embodiments, a method of forming a polymeric composite material may include introducing at least one polyol and inorganic filler to a first conveying section of the extruder, transferring the at least one polyol and inorganic filler to a first mixing section of an extruder, mixing the at least one polyol and the inorganic filler in the first mixing section, transferring the mixed at least one polyol and inorganic filler to a second conveying section of the extruder, introducing a di- or poly-isocyanate to the second conveying section, transferring the mixed at least one polyol and inorganic filler and the di- or poly-isocyanate to a second mixing section, mixing the mixed at least one polyol and inorganic filler with the di- or poly-isocyanate in the second mixing section of the extruder to provide a composite mixture, and transferring the composite mixture to an output end of the extruder.

In some embodiments, the conveying sections and mixing sections may be defined in terms of the screw segments and screw elements contained within the conveying or mixing section. In some embodiments, the first conveying section may include one or more transfer screws. In some embodiments, the first mixing section may include a slotted screw. In some embodiments, the first mixing section may include a lobal screw. In some embodiments, the first mixing section may include a lobal screw and a slotted screw.

In some embodiments, the second conveying section may be located downstream of a first conveying section. In some embodiments, the second conveying section may be located downstream of a first mixing section. In some embodiments, the section conveying section may include one or more transfer screws.

In some embodiments, a second mixing section may be located downstream of a first mixing section. In some embodiments, a second mixing section may be located downstream of the second conveying section. In some embodiments, the second mixing section may be adjacent to the output end of the extruder. In some embodiments, the second mixing station includes a reverse screw. In some embodiments, the reverse screw includes a reverse slotted screw.

In some embodiments, the method may further include adding one or more components of the composite mixture in the first conveying section of the extruder. Such additional components are further described herein. In some embodiments, the one or more components may be selected from the group consisting of a catalyst, a surfactant, and a blowing agent. In other embodiments, the one or more components may include one or more of a cross linker, a chain extender, and a coupling agent. In certain of these embodiments, the method may further include blending the one or more components with the at least one polyol prior to introduction to the first conveying section.

In some embodiments, the method further includes mixing the at least one polyol and inorganic filler and the di- or poly-isocyanate in a third mixing section subsequent to the second conveying section and prior to the second mixing section. In some embodiments, the third mixing section includes a reverse screw. Some embodiments further include introducing fibrous material in the third conveying section. In some embodiments, the third conveying section is located between the second mixing section and the third mixing section.

As described herein, one or more fibrous materials may be extruded with the polymeric composite material. In some embodiments, the method further includes introducing fibrous material in the second conveying section. In some embodiments, the method includes mixing the fibrous material with the mixed at least one polyol and inorganic filler and the di- or poly-isocyanate in the second mixing section.

In some embodiments, the method includes introducing at least one polyol, a di- or poly-isocyanate, and inorganic filler to a first conveying section of the extruder. In some embodiments, the first conveying section includes one or more transport screws. The method further includes transferring the at least one polyol, the di- or poly-isocyanate, and the inorganic filler to a first mixing section of an extruder, mixing the at least one polyol, the di- or poly-isocyanate and the inorganic filler in the first mixing section to producing a composite material. In some embodiments, the first mixing section includes a reverse screw. The method further includes transferring the composite mixture to an output end of the extruder. In some embodiments, the first mixing section includes a lobal screw.

In the methods described above, the method may further include introducing fibrous material in the first conveying section and mixing the fibrous material with the at least one polyol, the di- or poly-isocyanate and the inorganic filler in the first mixing section. In some embodiments, the method includes mixing a catalyst with the at least one polyol, the di- or poly-isocyanate and the inorganic filler. According to some embodiments, the catalyst is mixed prior to the composite mixture exiting an output end of the extruder. In some embodiments, the method includes extruding the composite mixture through a die.

In some embodiments a self-cleaning die may be used. In other embodiments the die may be continually rotated, on a closed bearing, while a fixed guide, pin, or rigid squeegee scrapes gelled material from the interior of the die.

A further aspect disclosed in this application is a new type of forming system utilizing up to six belts. The forming system is uniquely suited to the continuous forming of a range of product sizes with intricate molded-in detail. Materials that may be formed using the described system include but are not limited to: thermoplastic and thermoset plastic compounds, highly-filled plastic compounds, elastomers, ceramic materials, and cementitious materials. The system is particularly suited to the forming of foamed materials. The material to be formed may be poured, dropped, extruded, spread, or sprayed onto or into the forming system.

Some embodiments includes a system for providing shape, surface features, or both, to a moldable material, the system having:
at least two first opposed flat endless belts disposed a first distance apart from each other, each having an inner surface and an outer surface;
at least two second opposed flat endless belts disposed substantially orthogonal to the first two opposed endless belts and a second distance apart from each other, and each having an inner surface and an outer surface;
a mold cavity defined at least in part by the inner surfaces of at least two of the opposed flat endless belts; and
a drive mechanism for imparting motion to at least two of the opposed flat endless belts.

A more particular embodiment relates to a forming system having 4 flat belted conveyors configured so as to define and enclose the top, bottom, and sides of a 4-sided, open-ended channel, and an additional two profiled mold-belts that are configured to fit snugly, face-to-face within the channel provided by the surrounding flat belts. All belts are endless and supported by pulleys at the ends of their respective beds so as to allow each belt to travel continuously about its fixed path.

Some embodiments relate to a method of continuously forming a moldable material to have a desired shape or surface feature or both, comprising:
introducing the moldable material into an end of a mold cavity formed at least in part by the inner surfaces of two substantially orthogonal sets of opposed flat belts;
exerting pressure on the moldable material through the opposed flat belts;
transferring the moldable material along the mold cavity by longitudinal movement of the belts;
after sufficient time for the material to cure or harden into the molded configuration and thereby form molded material, removing the molded material from the mold cavity.

The system and method are versatile, permitting the production of a range of product sizes and profiles using the same machine. In an exemplary embodiment, the system and method provide for the continuous forming of synthetic lumber, roofing tiles, molded trim profiles, siding or other building products from heavily-filled, foamed thermoset plastic compounds and/or foamed ceramic compounds with organic binders.

Some embodiments further provides a continuous forming apparatus for molding foaming material into foam products. According to some embodiments, the continuous forming apparatus includes a first endless belt for molding the foam material, a first plurality of cleats, and a second plurality of cleats opposed to the first plurality of cleats.

The first endless belt may impart surface features or texture to the product surface, and may also incorporate non-stick films or compounds as mold release agents. The first endless belt may be rolled or folded so as to define a mold cavity. The mold belt cavity may impart any 3-dimensional shape, profile, texture, or features into the foam product.

The first plurality of cleats may have a three-dimensional abutment surface to provide transverse and lateral support to the first endless belt. The first plurality of cleats may also be shaped to provide transverse and lateral support to the foam material as it cures and is molded. The second plurality of cleats may have a flat abutment surface or a three-dimensional abutment surface depending on the size and complexity of the foam part to be molded.

The continuous forming apparatus may also include a drive mechanism for imparting motion to the first endless belt, the first plurality of cleats, and the second plurality of cleats. The drive mechanism may be connected to the first endless belt, the first plurality of cleats, and the second plurality of cleats so that they move at the same speed. By moving at the same speed, the first plurality of cleats and the second plurality of cleats may grip the first endless belt to provide constant support to the first endless belt as a molded foam product is cured and to reduce the friction resulting from moving the first endless belt.

The continuous forming apparatus may comprise a first attachment chain connecting the first plurality of cleats together and a second attachment chain connecting the second plurality of cleats together. The attachment chains permit the plurality of cleats to form an endless loop that provides constant support to the first endless belt as a molded foam product is cured. Furthermore, the attachment chains are used to space each cleat of each plurality of cleats. The attachment chains keep each cleat close to the adjacent cleats to support the endless belts without overlapping or binding with the adjacent cleats. By keeping each cleat close to the adjacent cleats, the unsupported sections of the endless belts are kept to a minimum.

The continuous forming apparatus may also include a second endless belt that cooperates with the first endless belt to mold the foam material. The second endless belt may be supported by the second plurality of cleats. In some configurations, the second plurality of cleats may include a three-dimensional abutment surface that grips the second endless belt and provides transverse and lateral support to the second endless belt. Together, the first endless belt and the second endless belt may define a mold cavity for forming a molded foam product. The plurality of cleats supports the first endless belt and the second endless belt against the high pressures that may be experienced as the foam material is molded within the continuous forming apparatus.

The continuous forming apparatus may also include a third endless belt and a fourth endless belt that cooperate with the first endless belt and the second endless belt to mold the foam material. The continuous forming apparatus may further comprise a third plurality of cleats and a fourth plurality of cleats disposed generally orthogonal to the first plurality of cleats and the second plurality of cleats. The third endless belt may be supported by the third plurality of cleats and the fourth endless belt may be supported by the fourth plurality of cleats.

In configurations where the third endless belt and the fourth endless belt are disposed orthogonally to the first endless belt and the second endless belt, the continuous forming apparatus may be used to efficiently produce a range of simulated lumber products in sizes such as 2×2, 2×4, 2×6, 2×8, 2×10, and 2×12, by adjusting the distance between the third endless belt and the fourth endless belt.

The continuous forming apparatus may have a third attachment chain connecting the third plurality of cleats together and a fourth attachment chain connecting the fourth plurality of cleats together. The third and fourth pluralities of cleats help to control the distance between the third endless belt and the fourth endless belt over the length of the continuous forming apparatus.

The first endless belt may include an insert support feature for positioning inserts within the mold cavity prior to adding foam material to the mold cavity. Furthermore, the first endless belt may comprise a mold cavity for molding a discrete foam part. By forming a mold cavity shaped to mold a discrete foam part, discrete foam parts may be made inexpensively on a continuous basis. Specifically, the first endless belt comprising a plurality of discrete mold cavities may produce discrete foam parts less expensively than using several discrete molds.

The first endless belt may also be supported by the first plurality of cleats to form a curved cross sectional area for molding foam material. In some configurations, the first endless belt may also be supported by the second plurality of cleats to form a circular cross sectional area for molding foam material into a cylindrical product.

The continuous forming apparatus may also comprise a first frame disposed to support the first plurality of cleats and a second frame disposed to support the second plurality of cleats. The frames provide support for the cleats to support the first and second endless belts and permit the continuous forming apparatus to be used with foam materials that exert relatively high pressures against the mold such as thermoset plastics that are cured in an exothermic reaction and coupled with a foaming agent.

The frames also permit a transverse gap to be disposed between the first plurality of cleats and the second plurality of cleats when the first plurality of cleats supports the first endless belt for molding foam material. The gap is closed by one or more of the endless belts to prevent the foaming material from exiting the mold cavity. Additionally, leaving a small gap between the first plurality of cleats and the second plurality of cleats may help to prevent the first plurality of cleats from binding with the second plurality of cleats. The gap may range from about an inch to almost abutting but preferably is about 0.1 inches. Of course, the first plurality of cleats may abut the second plurality of cleats when the first plurality of cleats supports the first endless belt for molding foam material.

The forming unit belts may be continuously heated to about 100° f to about 130° F.; about 105° to about 125° F.; or about 110° to about 120° F. by the use of heating devices, such as IR heaters. This allows faster drying of the liquid mold release and faster curing of the products surface, therefore giving faster release from the belts.

Thermosetting polymeric composite materials may be made using an extruder. Such a process allows for thorough mixing of the various components of the polymeric composite material in the extruder. The screw and screw elements may be configured in various ways within an extruder to provide a substantially homogeneous mixture of the various components of the polymeric composite material. In addition, friction and other forces may promote the reaction of various monomers and other additives that create a polymeric matrix in the polymeric composite material. Moreover, the various components of a polymeric composite material may be added in different orders and at different positions in an extruder. Thus, extrusion of polymeric composite material is a desirable method for providing a medium for reaction, controlling reaction ingredients and conditions, and mixing the various components.

An extruder having one or more material inputs may be used to form such polymeric composite materials. In accordance with some embodiments, a single screw extruder or a twin screw extruder may be used. Each screw of the extruder is mounted on a single shaft that transmits rotary motion to the screw. In embodiments of a twin screw extruder, each screw may be counter rotary to the other screw. The screw may comprise one or more screw elements mounted on the rotating shaft. The screw may alternatively be assembled from several separate screw elements, each of which forms a portion of the screw operated within the extruder. Screw elements may be rotatably disposed in an appropriate sequence of the axial shaft to form multiple segments of the screw. Various screw elements may include one or more of transport screw elements, lobal screw elements, reverse screw elements, slotted screw elements, and kneading block elements. Various screw elements are described in U.S. Pat. Nos. 5,728,337, 6,136,246 and 6,908,573, which are hereby incorporated by reference.

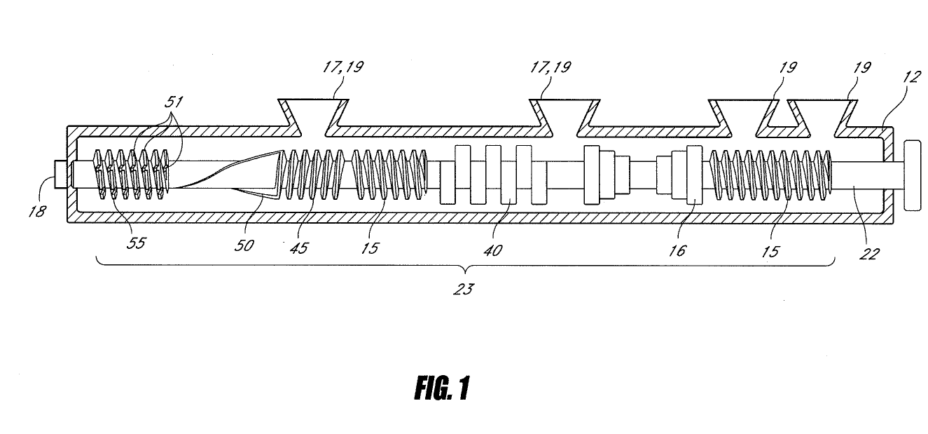

Referring to FIG. 1, an extruder body 12 contains a screw body which includes a screw shaft 22 and a plurality of screw elements 23. The extruder body 12 is outfitted with one or more vents 17 which allow air to escape from composite materials and the extruder body 12. The screw body also includes one or more feed sections 19 where components of the polymeric composite are fed into respective segments of the extruder body 12. The extruder body also includes outlet 18. Outlet 18 may be equipped with a die. Screw elements 23 include a transport screw elements 15, a kneading blocks 16 and 40, a reverse transport screw element 45, a lobal screw element 50, and a slotted screw element 55. While the various screw segments may be connected to or engaged with the screw shaft 22 in any manner, spine fitting grooves may be mated to a spined screw shaft.

In some embodiments, transport screw elements have a flight that is helically wound around the screw. The flight of the transport screw has a positive pitch and therefore transfers materials in the extruder barrel from the feed end to the output end. According to some embodiments, the flight of the transport screw may be made faster or slower, depending on the pitch of the threads of the transport screw element. In a transport screw, a greater pitch (i.e., threads/per unit of length) will result in slower transport of the material, while a lower pitch will result in faster transport of the material. Many different varieties of transport screw elements may be used. In some embodiments, utilizing a twin screw extruder, each screw may contain transport screw elements that are intermeshed. While transport screw elements mix some composite material, the primary function is conveying materials downstream in the extruder.

In some embodiments, the extruder may comprise one or more reverse screw element 45. These are generally utilized to reverse the flow of the composite materials toward the feed end of the extruder. As such, a reverse screw element 45 blocks the flow of components of the composite mixture, thus acting as a temporary seal and promotes added blending of the components and dispersion of fillers and other additives. In some embodiments, such components of the composite mixture may pass the reverse screw element after another shearing force or pressure allows the components to pass the reverse screw element. In some embodiments, the reverse screw element allows for substantial mixing of filler and other polymer composite materials.

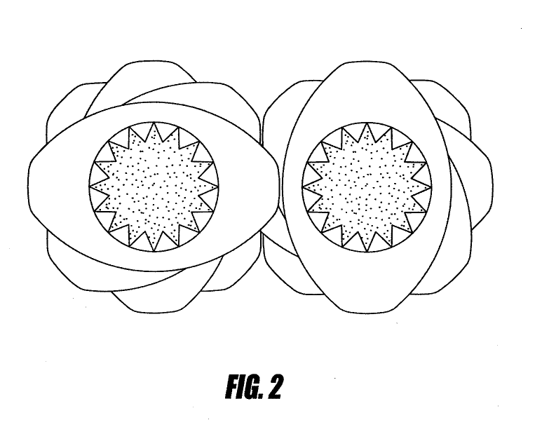

As shown in FIG. 2, a kneading block 25 is a screw element that includes a plurality of double-tipped kneading discs having a substantially oval cross section and arranged in the axial direction of the screw shaft. Each kneading disc may be displaced from one another. In twin screw extruders, kneading discs of the first screw are kept staggered at about 90 degrees to the corresponding kneading discs on the second screw. An alternative embodiment of kneading blocks may include the configuration of kneading block 40 as shown in FIG. 1. Kneading blocks typically have from about 4 to about 6 blades per screw element. Kneading blocks are typically used to provide high shear stress and high mixing strengths, particularly when mixing solids with liquids (or melted plastics). Kneading blocks are generally self-wiping.

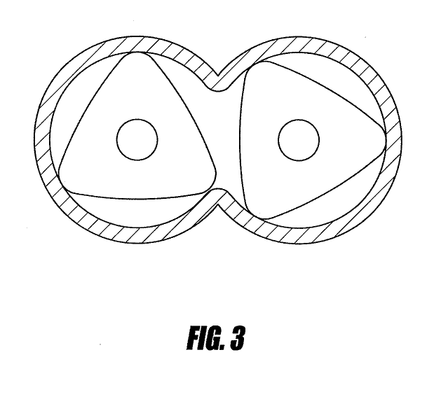

Lobal screw elements are generally a longer screw element. In some embodiments, a lobal screw element has 2 or 3 or more faces. In some embodiments, the lobal screw may be polygonal. Lobal screw elements do not comprise a plurality of discs like kneading blocks. Instead, lobal screw elements are generally a single structure. However, lobal screw elements may have one or more axial twists. In some embodiments, the axial twist of a lobal screw element is less than 180°. In some embodiments, the axial twist of a lobal screw element is less than 140°. In some embodiments, the axial twist of a lobal screw element is less than 90°. In some embodiments, the axial twist of a lobal screw element is less than 45°. In some embodiments, the axial twist of a lobal screw element is substantially 0°. One purpose of a lobal screw element is to squeeze various composite material in a defined space. Such lobal screw elements cause very high shear in the defined area. It has been discovered that lobal screw elements may force liquids to mix intimately with one another. In additionally embodiments, lobal screw element can provide substantial wetting of inorganic materials such as fibers and fillers by liquid components of the polymeric composite material, such as melted resins or liquid monomers. Lobal screw elements may be neutral or forward moving elements. Lobal screw elements are typically self-wiping in a twin screw extruder configuration as shown in FIG. 3.

Slotted screw elements 55 may include a plurality of blades on all sides of the screw elements. In some embodiments, the blades may be disposed in line with other blades, such as a transfer screw element with spaces or slots between the helically wound flight. However, there is no requirement for the blades to be uniform or to have positive pitch. In some embodiments, a slotted screw blade includes angled ends. In some embodiments, the slotted screws have positive, negative, and neutral pitch (i.e., they may convey or block the composite material according to the type and arrangement of blades). However, some blades with angles ends may produce less conveying effect than a screw such as a transfer screw. In some embodiments, slotted screws are partially self-wiping. In some embodiments, slotted screws are not self wiping in a twin screw arrangement. In some embodiments, the slots of the slotted screw element may be filled with one or more composite materials, such as a hardened urethane. As a result, such slotted screw elements may produces substantial amount of mixing of various components of the mixture and also knead the mixture. In particular embodiments, slotted screws may be placed toward the feed end of an extruder which allows slots not to fill with polymeric resin, such as hardened polyurethane. Example of slotted screw elements may be found in U.S. Pat. No. 6,136,246.

Advantageously, these screw elements may be used to produce a desired amount of blending of components of the polymeric composite system. In some embodiments, each screw element defines a segment of the extruder. In some embodiments, the segments may have substantially the same length. However, certain segments may have longer lengths than other segments and segments may also contain more than one screw element. In some embodiments, the extruder may have up to nine extruder segments. However, the extruder may container more or less segments depending on the desired composite material characteristics. In some embodiments, the extruder includes 1, 2, 3, 4, 5, 6, 7, 8, or 9 segments.

In some embodiments the extruder screw speed may be greater than about 600 rpm with screw diameters less than about 60 mm. In other embodiments, screw diameter may be greater than about 60 mm and the extruder screw speed may be greater than about 400 rpm. This may provide the proper mixing of the isocyanate and the polyols, as well as good wetting of the filler.

Various segments of the extruder may be air or water cooled. Often, exothermic reactions during the production of the polymeric composite material may require sufficient cooling to prevent runaway exotherms. Such temperatures and cooling may be controlled by various means known to persons having ordinary skill in the art.

One or more components of the polymeric composite material may be introduced into one or more segments of the extruder through hoppers, feed chutes, or side feeders. One or more components may also be metered into the extruder through various means. Continuous feeding of the respective components of the polymeric composite material results in a continuous process of extruding the polymeric composite material.

Depending on the exact arrangement of the screw elements, the segments may further be classified into broader sections such as conveying sections and mixing sections. For example, a first composite component may be introduced in a first segment having a first transport screw, and a second composite component may be introduced in a second segment have a second transport screw. If such first and second segments are adjacent to each other, then the first and second segment may be classified as a conveying section. However, classification as a conveying section does not preclude mixing; even intimate mixing, of the various components of the polymeric composite material.

Such composite components may then be further transferred into other segments or sections. The components generally are transferred by the screws from the feed end to the discharge end of the extruder. In some embodiments, components are transferred into a mixing section. A mixing section may include a kneading blocks or reverse screws. Reverse screws have negative pitch. Thus, the reverse screws may block the materials until sufficient shearing forces the various components of the composite material through this barrel segment. Generally, this results in substantial mixing of the various components of the composite material.

In some embodiments the extruder may be operated with cooling water run through it, keeping the barrel temperatures at about 35° to about 70° F., about 40° to about 65° F., about 45° to about 60° F., or about 50° to about 55° F.

In some embodiments a liquid mold release may be automatically and continuously put on the forming unit's belts by spray, sponges, brushes, or hard or soft rollers. In some embodiments the mold release may be a paint primer itself. In other embodiments a paint primer may be applied on the belts after the separate addition of the mold release.

In some embodiments building products may be produced with these formulations that may yield about 1600 to about 2000 psi flexural strength; about 1650 to about 1950 psi flexural strength; about 1700 to about 1900 psi flexural strength; or about 1750 to about 1850 psi flexural strength at about 30 pcf density to about 50 pcf density, or about 40 pcf density.

It has been discovered that some embodiments of extruders are able to produce highly filled polyurethane composite materials. Various components of the polymer composite material may include one or more of the following: at least polyol, at least one monomer or oligomeric di- or poly-isocyanates, an inorganic filler, fibrous materials, at least one catalyst, surfactants, colorants, and other various additives. Such components are further described herein.

Described herein are polymeric composite materials. In particular embodiments, the polymeric composite material include polyurethane composite materials. While the embodiments described herein are specifically related to polyurethane composite materials, the technology may also be applicable to many other polymeric resins, particularly those related to highly filled thermosetting polymers. Generally, a polyurethane is any polymer consisting of a chain of organic units joined by urethane linkages. Typically, a polyurethane may be formed by reaction of one or more monomeric or oligomeric poly- or di-isocyanates (sometimes referred to as “isocyanate”) and at least one polyol, such as a polyester polyol or a polyether polyol. These reactions may further be controlled by various additives and reaction conditions. For example, one or more surfactants may be used to control cell structure and one or more catalysts may be used to control reaction rates. Advantageously, the addition of certain polyol and isocyanate monomers and certain additives (e.g., catalysts, crosslinkers, surfactants, blowing agents), may produce a polyurethane material that is suitable for commercial applications.

As is well known to persons having ordinary skill in the art, polyurethane materials may also contain other polymeric components by virtue of side reactions of the polyol or isocyanate monomers. For example, a polyisocyanurate may be formed by the reaction of optionally added water and isocyanate. In addition, polyurea polymers may also be formed. In some embodiments, such additional polymer resins may have an effect on the overall characteristics of the polyurethane composite material.

It has further been found that some portion of the polymeric component of polyurethanes may be replaced with one or more fillers such as particulate material and fibrous materials. With the addition of such fillers, the polyurethane composite materials may still retain good chemical and mechanical properties. These properties of the polyurethane composite material allows for its use in building materials and other structural applications. Advantageously, the polyurethane composite material may contain large loadings of filler content without substantially sacrificing the intrinsic structural, physical, and mechanical properties of the polymer. Such building materials would have advantages over composite materials made of less or no filler. For example, the building materials may be produced at substantially decreased cost. Furthermore, decreased complexity of the process chemistry may also lead to decreased capital investment in process equipment.

In some embodiments, the composite materials have a matrix of polymer networks and dispersed phases of particulate or fibrous materials. The polymer matrix includes a polyurethane network formed by the reaction of a poly- or di-isocyanate and one or more polyols. The matrix is filled with a particulate phase, which can be selected from one or more of a variety of components, such as fly ash particles, axially oriented fibers, fabrics, chopped random fibers, mineral fibers, ground waste glass, granite dust, slate dust or other solid waste materials. The addition of water can also serve to provide a blowing agent to the reaction mixture, resulting in a foamed structure, if such is desired.

A composite material may be advantageously used as structural building material, and in particular as synthetic lumber, for several reasons. First, it has the desired density, even when foamed, to provide structural stability and strength. Second, the composition of the material can be easily tuned to modify its properties by, e.g., adding oriented fibers to increase flexural stiffness, or by adding pigment or dyes to hide the effects of scratches. This can be done even after the material has been extruded. Third, such polyurethane composite materials may also be self-skinning, forming a tough, slightly porous layer that covers and protects the more porous material beneath. Such tough, continuous, highly adherent skin provides excellent water and scratch resistance. In addition, as the skin is forming, an ornamental pattern (e.g., a simulated wood grain) can be impressed on it, increasing the commercial acceptability of products made from the composite. In some embodiments, an ornamental pattern may be in a mold, and the pattern is molded into the composite material,

Some embodiments include a polymer matrix composite material, comprising:
(1) a polyurethane formed by reaction of
   (a) one or more monomeric or oligomeric poly- or di-isocyanates;
   (b) a first polyether polyol having a first molecular weight; and
   (c) an optional second polyether polyol having a second molecular weight lower than the first molecular weight; and
(2) optionally, a polyisocyanurate formed by reaction of a monomeric or oligomeric poly- or di-isocyanate with water or other blowing agents;
(3) a particulate inorganic filler.

As indicated above, a polymer matrix composite material can have a variety of different uses. However, it is particularly suitable in structural applications, and in particular as a synthetic lumber. Accordingly, some embodiments relate to a synthetic lumber, comprising the polymer matrix composite material described above, and having a relatively porous material and a relatively non-porous toughening layer disposed on and adhered to the porous material.

It has been found that the process used to manufacture the polymer matrix composite material and the synthetic lumber formed therefrom can have an important impact on the appearance and properties of the resulting material, and thus on its commercial acceptability. Accordingly, some embodiments relate to a method of producing a polymer matrix composite, by:
(1) mixing a first polyether polyol having a first molecular weight and a second polyether polyol having a second molecular weight higher than the first molecular weight with a catalyst, optional water, and optional surfactant;
(2) optionally introducing reinforcing fibrous materials into the mixture;
(3) introducing inorganic filler into the mixture;
(4) introducing poly- or di-isocyanate into the mixture; and
(5) allowing the exothermic reaction to proceed without forced cooling except to control runaway exotherm.

The materials of the composite materials, and the process for their preparation, are environmentally friendly. They provide a mechanism for reuse of particulate waste in a higher valued use, as described above. In addition, the process for making them optionally uses water in the formation of polyisocyanurate, which releases carbon dioxide as the blowing agent. The process thus avoids the use of environmentally harmful blowing agents, such as halogenated hydrocarbons.

As described above, some embodiments relate to a composite composition containing a polymeric matrix phase and a dispersed inorganic particulate phase, and which can contain other materials, such as reinforcing fibers, pigments and dyes, and the like. One of the desirable properties of the material is its self-skinning nature.

The polymeric phase desirably contains at least a polyurethane, generally considered to be a 2-part or thermosetting polyurethane.

Described herein are certain improvements that may be used in the production of polyurethane composite materials. Some previously described polyurethane composite material systems are included in U.S. patent application Ser. No. 10/764,012, filed Jan. 23, 2004, and entitled “FILLED POLYMER COMPOSITE AND SYNTHETIC BUILDING MATERIAL COMPOSITIONS,” now published as U.S. Patent Application Publication No. 2005-163969-A1, and U.S. patent application Ser. No. 11/190,760, filed Jul. 27, 2005, and entitled “COMPOSITE MATERIAL INCLUDING RIGID FOAM WITH INORGANIC FILLERS,” now published as U.S. Patent Application Publication No. 2007-0027227 A1, which are both hereby incorporated by reference in their entireties. However, in no way, are such polyurethane composite material systems intended to limit the scope of the improvements described in the present application.

The various components and processes of preferred polyurethane composite materials are further described herein:

### Monomeric or Oligomeric Poly or Di-Isocyanates

As discussed above, one of the monomeric components used to form a polyurethane polymer of the polyurethane composite material is one or more monomeric or oligomeric poly or di-isocyanates. The polyurethane is formed by reacting a poly- or di-isocyanate. In some embodiments, an aromatic di-isocyanate or polyisocyanate may be used.

In some embodiments methylene diphenyl di-isocyanate (MDI), with one or more polyether polyols, described in more detail below, may be used.

The MDI can be MDI monomer, MDI oligomer, or mixtures thereof. The particular MDI used can be selected based on the desired overall properties, such as the amount of foaming, strength of bonding to the inorganic particulates, wetting of the inorganic particulates in the reaction mixture, strength of the resulting composite material, and stiffness (elastic modulus). Although toluene di-isocyanate can be used, MDI is generally preferable due to its lower volatility and lower toxicity. Other factors that influence the particular MDI or MDI mixture are viscosity (a low viscosity is desirable from an ease of handling standpoint), cost, volatility, reactivity, and content of 2,4 isomer. Color may be a significant factor for some applications, but does not generally affect selection of an MDI for preparing an article.

In some embodiments, components of the reaction mixture such as isocyanates or polyols may have low viscosities. For example,

i) one or more of a polyol,

ii) a combination of polyols,

iii) the isocyanate, or

iv) a combination the polyols and the isocyanate,

may have a viscosity in a range of: about 1 cP to about 5000 cP, about 1 cp to about 1500 cP, about 1 cP to about 2000 cP, about 1 to about 1000 cP, about 1 to about 100 cP; about 100 cP to about 200 cP; about 200 cP to about 300 cP; about 300 cP to about 400 cP; about 400 cP to about 500 cP; about 500 cP to about 600 cP; about 600 cP to about 700 cP; about 700 cP to about 800 cP; about 800 cP to about cP; about 900 cP to about 1000 cP; about 1000 cP to about 1500 cP; or about 1500 cP to about 2000 cP. In some embodiments, low viscosity components such as polyols or isocyanates may be used to get a high percent of filler into the mixture for extrusion.

In some embodiments, adding a high percentage of filler to low viscosity isocyanates and/or polyols may provide a high viscosity mix that may be used to make the polyurethane composite material extrudable in the twin screw extruder. In some embodiments, the mix exiting the die, or nozzle or hole, may have a viscosity allowing the mix to not “run.” For example, the viscosity may be high enough to allow the uncured mixture exiting the hole to remain thoroughly mixed. Furthermore, the viscosity may be high enough to allow the composite mixture exiting the hole to retain its shape sufficiently well to cure without requiring a mold. The viscosity of the composite mixture exiting the mold may be sufficiently low as to allow the composite mixture to be shaped by the forming unit and/or belts. In some embodiments, the viscosity of the composite mixture may still be sufficiently low to foam. For example, the viscosity of the mix may be in the range of: about 1 to about 3500 cP; about 1000 cP to about 3000 cP; about 1000 cP to about 1500 cP; about 1500 cP to about 2000 cP; about 2000 cP to about 2500 cP; or about 2500 cP to about 3000 cP; about 1000 cP to about 1100 cP; about 1100 cP to about 1200 cP; about 1200 cP to about 1300 cP; about 1300 cP to about 1400 cP; about 1400 cP to about 1500 cP; about 1500 cP to about 1750 cP; about 1750 cP to about 2000 cP; about 2000 cP to about 2250 cP; about 2250 cP to about 2500 cP; about 2500 cP to about 2750 cP; about 2750 cP to about 3000 cP; about 3000 cP to 3250 cP; about 3250 cP to about 3500 cP; about 5000 cP to about 10,000 cP; about 10,000 cP to about 30,000 cP; about 30,000 cP to about 50,000 cP; about 50,000 cP to about 100,000 cP; or about 100,000 cP to about 250,000 cP.

Light stability is also not a particular concern for selecting MDI for use in the composite material. According to some embodiments, the composite material allows the use of isocyanate mixtures not generally regarded as suitable for outdoor use, because of their limited light stability. When used to form the polyurethane composite material, such materials surprisingly exhibit excellent light stability, with little or no yellowing or chalking. Since isocyanate mixtures normally regarded as suitable for outdoor use (generally aliphatic isocyanates) are considerably more expensive than those used herein, use of MDI mixtures may represent a significant cost advantage.

Suitable MDI compositions include those having viscosities ranging from about 25 to about 200 cp at 25° C. and NCO contents ranging from about 30% to about 35%. Generally, isocyanates are used that provide at least 1 equivalent NCO group to 1 equivalent OH group from the polyols, desirably with about 5% to about 10% excess NCO groups. Useful polyisocyanates also may include aromatic polyisocyanates. Suitable examples of aromatic polyisocyanates include 4,4-diphenylmethane di-isocyanate (methylene diphenyl di-isocyanate), 2,4- or 2,6-toluene di-isocyanate, including mixtures thereof, p-phenylene di-isocyanate, tetramethylene and hexamethylene di-isocyanates, 4,4-dicyclohexylmethane di-isocyanate, isophorone di-isocyanate, mixtures of 4,4-phenylmethane di-isocyanate and polymethylene polyphenylisocyanate. In addition, tri-isocyanates such as, 4,4,4-triphenylmethane tri-isocyanate 1,2,4-benzene tri-isocyanate; polymethylene polyphenyl polyisocyanate; and methylene polyphenyl polyisocyanate, may be used. Isocyanates are commercially available from Bayer USA, Inc. under the trademarks MONDUR and DESMODUR. Suitable isocyanates include Bayer MRS-4, Bayer MR Light, Dow PAPI 27, Bayer MR5, Bayer MRS-2, and Huntsman Rubinate 9415.

In some embodiments, the average functionality of the isocyanate component is between about 1.5 to about 4. In other embodiments, the average functionality of the isocyanate component is about 3. In other embodiments, the average functionality of the isocyanate component is less than about 3, including, about 1.8, 1.9, 2.0, 2.1, 2.2, 2.3, 2.4, 2.5, 2.6, 2.7, 2.8, and 2.9. In some embodiments, the isocyanate has a functionality of about 2. Some of these embodiments produce polyurethane composite materials with higher mechanical strengths and lower costs than polyurethane composite material comprising more than about 2.

As indicated above, an isocyanate may be reacted with one or more polyols. In general, the ratio of isocyanate to polyol (isocyanate index), based on equivalent weights (OH groups for polyols and NCO groups for isocyanates) is generally in the range of about 0.5:1 to about 1.5:1, more particularly from about 0.8:1 to about 1.1:1, and in some embodiments, from about 0.8:1 to about 1.2:1. Ratios in these ranges provide good foaming and bonding to inorganic particulates, and yields low water pickup, fiber bonding, heat distortion resistance, and creep resistance properties. However, precise selection of the desired ratio will be affected by the amount of water in the system, including water added per se as a foaming agent, and water introduced with other components as an “impurity.”

In some embodiments, an isocyanate may be selected to provide a reduced isocyanate index. It has been discovered that the isocyanate index can be reduced without compromising the polyurethane composite material's chemical or mechanical properties. It is additionally advantageous according to some embodiments to use an isocyanate with a reduced isocyanate index as isocyanates are generally higher priced than polyols. Thus, a polyurethane system formed by an isocyanate monomer with a reduced isocyanate index may result in reduced cost of producing the total system.

### Polyols

According to some embodiments, the polyurethane polymer is a reaction product of one or more polyols with an isocyanate. The one or more polyols used may be single monomers, oligomers, or blends. Mixtures of polyols can be used to influence or control the properties of the resulting polymer network and composite material. For example, mixtures of two polyols, one a low molecular weight, rigid (relative to the second) polyol and the other a higher molecular weight, more rubbery (relative to the first) polyol. The amount of rigid polyol is carefully controlled in order to avoid making the composite too brittle. An amount of flexible polyol of between about 5 wt % and about 20 wt %, more particularly around 15 wt %, based on the total weight of the flexible and rigid polyols being 100 wt %, has generally been found to be suitable. The properties, amounts, and number of polyols used may be varied to produce a desired polyurethane composite material. It is generally desirable to use polyols in liquid form, and generally in the lowest viscosity liquid form available, as these can be more easily mixed with the inorganic particulate material. So-called “EO” tipped polyols can be used; however their use is generally avoided where it is desired to avoid “frosting” of the polymer material when exposed to water.

In some embodiments, the at least one polyol include a polyester or polyether polyol. Polyether polyols are commercially available from, for example, Bayer Corporation under the trademark MULTRANOL. In general, desirable polyols include polyether polyols, such as MULTRANOL (Bayer), including MULTRANOL 3400 or MULTRANOL 4035, ethylene glycol, polypropylene glycol, polyethylene glycol, diethylene glycol, triethylene glycol, dipropylene glycol, glycerol, 2-pentane diol, pentaerythritol adducts, 1trimethylolpropane adducts, trimethylolethane adducts, ethylendiamine adducts, and diethylenetriamine adducts, 2-butyn-1,4-diol, neopentyl glycol, 1,2-propanediol, pentaerythritol, mannitol, 1,6-hexanediol, 1,3-butylene glycol, hydrogenated bisphenol A, polytetramethyleneglycolethers, polythioethers, and other di- and multi-functional polyethers and polyester polyethers, and mixtures thereof. The polyols need not be miscible, but should not cause compatibility problems in the polymeric composite.

In some embodiments, plant-based polyols are used as at least one polyol. These polyols are lower in cost, and not dependent on the price and availability of petroleum. In some embodiments, the plant-based polyols provide a polyurethane system that is substantially identical to that provided by oil-based polyols. In other embodiments, plant-based polyols can be used to replace at least a portion of the oil-based polyols. By employing plant-based polyols, the polyurethane composite material is more environmentally safe and friendly. In addition, certain equipment used to handle and dispose of oil-based polyols may be costly.

In some embodiments, the at least one polyol is a polyester polyol that is substantially resistant to water soaking and swelling. Thus, these polyols can be used in the formation of polyurethane composite materials which, when cured, attracts less water. In certain cases, the polyester polyols absorb less water than polyether polyols. However, in some embodiments, polyester polyols and polyether polyols can be mixed in the formation of polyurethane composite material to provide better water resistance.

Some embodiments of the polyurethane composite material comprise at least one polycarbonate polyol. These embodiments provide higher impact and/or chemical resistance, as compared to polyurethane composite material made from polyester and/or polyether polyols. However, combinations of polycarbonate polyols, polyester polyols, and polyether polyols can be used in systems with high inorganic fillers to provide the desired mechanical and physical property of the polyurethane composite material. In some embodiments, building products comprising the polyurethane composite materials which employ at least one polyester polyol demonstrate improved water resistance.

In some embodiments, at least some phenolic polyols are used to make polyurethane composite materials which have improved flame retardancy as compared to those polyurethane composite materials that are not made from phenolic polyols. Such polyurethane composite materials may also be fire and smoke resistance.

In other embodiments, the polyurethane composite materials are made from at least one acrylic polyol. In some embodiments, the polyurethane composite materials made from the at least one acrylic polyol demonstrate improved weathering as compared to those that are not made from at least one acrylic polyol. In other embodiments, the polyurethane composite materials are made from at least one acrylic polyol exhibit substantially no discoloration when exposed to sunlight.

In some embodiments, a first polyol having a first hydroxyl number and a second polyol having a second hydroxyl number less than the first hydroxyl number may be used. Such combination of polyols form a first polyurethane that is less rigid than a second polyurethane that would be formed by the reaction of the first polyol in the absence of the second polyol. In some embodiments, the first polyol has a hydroxyl number ranging from about 250 to about 500 mg KOH/g. In some embodiments, the first polyol has a hydroxyl number ranging from about 300 to about 450 mg KOH/g. In some embodiments, the first polyol has a hydroxyl number ranging from about 320 to about 400 mg KOH/g. In some embodiments, the first polyol has a hydroxyl number ranging from about 350 to about 500 mg KOH/g. In some embodiments, the first polyol has a hydroxyl number ranging from about 370 to about 600 mg KOH/g. In some embodiments, the second polyol has a hydroxyl number less than the first polyol. In some embodiments, the second polyol has a hydroxyl number ranging from about 20 to about 120 mg KOH/g. In some embodiments, the second polyol has a hydroxyl number ranging from about 20 to about 70 mg KOH/g. In some embodiments, the second polyol has a hydroxyl number ranging from about 30 to about 60 mg KOH/g; about 50 to about 75 mg KOH/g; about 1 to about 150 mg KOH/g; about 1 to about 30 mg KOH/g; 30 to about 50 mg KOH/g; about 40 to about 60 mg KOH/g; about 50 to about 70 mg of KOH/g; about 70 to about 90 mg KOH/g; about 90 to about 110 mg KOH/g; about 110 to about 130 mg KOH/g; or about 130 to about 150 mg KOH/g.

The first polyol may be a rigid polyol. In some embodiments, a rigid polyol may have a relatively high polyol number such as about 250 mg KOH/g to about 500 mg KOH/g; about 300 mg KOH/g to about 5000 mg KOH/g; about 500 to about 1000 mg KOH/g; about 300 mg KOH/g to about 400 mg KOH/g; about 300 mg KOH/g to about 500 mg KOH/g; about 300 mg KOH/g to about 1000 mg KOH/g; about 400 mg KOH/g to about 500 mg KOH/g; about 500 to about 550 mg KOH/g; about 550 to about 600 mg KOH/g; about 600 to about 650 mg KOH/g; about 650 to about 700 mg KOH/g; about 700 to about 750 mg KOH/g; about 750 to about 800 mg; KOH/g; about 800 to about 850 mg KOH/g; about 850 to about 900 mg KOH/g; about 900 to about 950 mg KOH/g; or about 950 to about 1000 mg OH/g. In other embodiments a rigid polyol may have an intermediate polyol number such as about 1000 to about 5000 mg KOH/g; about 1000 to about 1250 mg KOH/g; about 1250 to about 1500 mg KOH/g, about 1500 to about 1750 mg KOH/g; about 1750 to about 2000 mg KOH/g; about 2000 to about 2250 mg KOH/g; about 2250 to about 2500 mg KOH/g; about 2500 to about 2750 mg KOH/g; about 2750 to about 3000 mg KOH/g; about 3000 to about 3250 mg KOH/g; about 3250 to about 3500 mg KOH/g; about 2500 to about 3750 mg KOH/g; about 3750 to about 4000 mg KOH/g; about 4000 to about 4250 mg KOH/g; about 4250 to about 4500 mg KOH/g; about 4500 to about 4750 mg KOH/g; or about 4750 to about 5000 mg KOH/g.

The molecular weight of a rigid polyol may vary. For example, a rigid polyol may have a molecular weight of: about 50 g/mol, about 80 g/mol, about 100 g/mol, about 150 g/mol, about 200 g/mol, about 300 g/mol, about 350 g/mol, about 400 g/mol, about 450 g/mol, about 500 g/mol, or any value in a range bounded by, or between, any of these molecular weights.

In some embodiments a combination of a rigid and a semi-flexible polyol may be used. A semi-flexible polyol may have an intermediate polyol number such as about 20 mg KOH/g to about 240 mg KOH/g; about 20 mg KOH to about 225 mg KOH/g; about; about 120 mg KOH/g to about 240 mg KOH/g; about 150 mg KOH/g to about 300 mg KOH/g; about 150 to about 250 mg KOH/g; about 150 to about 170 mg KOH/g; about 170 to about 190 mg KOH/g; about 190 to about 210 mg KOH/g; about 210 to about 230 mg KOH/g; about 230 to about 250 mg KOH/g; about 150 to about 500 mg KOH/g; about 250 to about 500 mg KOH/g; about 250 to about 300 mg of KOH/g; about 300 to about 350 mg KOH/g; about 350 to about 400 mg KOH/g; about 400 to about 450 mg KOH/g; or about 450 to about 500 mg/KOH/g.

The second polyol may be a flexible or a semi-flexible polyol. The molecular weight of a flexible or semi-flexible polyol may vary. For example, a flexible polyol or a semi-flexible polyol may have a molecular weight of: about 500 g/mol, about 550 g/mol, about 600 g/mol, about 700 g/mol, about 800 g/mol, about 900 g/mol, about 1000 g/mol, about 1500 g/mol, about 2000 g/mol, about 3000 g/mol, about 4000 g/mol, about 5000 g/mol, about 10,000 g/mol, about 50,000 g/mol, about 100,000 g/mol, or any value in a range bounded by, or between, any of these molecular weights.

In some embodiments a mixture of polyols, may have a hydroxyl number of at least about 150 mg KOH/g, about 200 mg KOH/g, or about 250 mg KOH/g; and/or up to about 300 mg KOH/g, about 350 mg KOH/g, 400 mg KOH/g, or about 425 mg KOH/g; and/or about 310 mg KOH/g; and or about 390 mg KOH/g. These hydroxyl numbers may be a hydroxyl number that does not include the contribution of water to the hydroxyl number and/or may be the hydroxyl number that would be obtained if the polyols contained no water.

For example, a first polyol such as Bayer's MULTRANOL 4500 may be used in combination with Bayer's ARCOL LG-56 and MULTRANOL 3900. In this case, the first polyol has a hydroxyl number ranging from 365-395 mg KOH/g. For ARCOL LG-56, the second polyol has a hydroxyl number ranging from 56.2 to 59.0 mg KOH/g. For MULTRANOL 3900 has a hydroxyl number ranging from 33.8 to 37.2 mg KOH/g. However, these examples are not intended to be limiting. Any number of polyol as described above may be selected for the hydroxyl number in controlling the flexibility or rigidity of a polyurethane product.

In some embodiments, mixture of polyols can be used to achieve the desired mechanical strength and rigidity of the final polyurethane composite material. In some embodiments, polyols with OH functionality between about 2 to about 7 can be used. In other embodiments, the average functionality of the polyols is between about 4 to about 7. The polyurethane composite materials become less expensive because the amount of isocyanate needed to react with the polyols to substantially form the desired polyurethane decreases. While this in some case may increase the rubberiness, non-brittleness, or flexibility of the polyurethane composite material, the correct balance of these functional polyols with OH functionality, between about 4 to about 8, maintains the mechanical properties of the polyurethane composite material, as compared to a polyurethane composite material made from polyols with an average functionality less than 4.

In some embodiments, the polyurethane composite material is made by using higher functional polyols in place of polyols having an average functionality of 2 or 3. In these embodiments, the polyurethane composite material has more cross linking. Some embodiments have higher impact strength, flexural strength, flexural modulus, chemical resistance, and water resistance as compared to the polyurethane composite material formed by polyols having a functionality of about 2 to about 3.

In some embodiments, the polyurethane composite material is made by using more than one polyol with different OH numbers to give the same weighted average OH number. Such polyurethane composite materials yield a more segmented polymer. By allowing many polyols of different functionality and/or molecular weight to be mixed together to make the needed OH number to balance the number of isocyanate groups, the orderliness of the resulting polymer chain is more segmented and less likely to align together. In some embodiments, the polyurethane composite material comprises three, four, five, or six types of polyols of different functionality and/or molecular weight. For example, a polyurethane system can be made from combination of multiple types of polyols, wherein at least one first polyol has an average functionality of about 2, wherein at least one second polyol has an average functionality of about 4, and wherein at least one third polyol has an average functionality of about 6. In some embodiments, the overall number of hydroxyl groups may be adjusted with varying polyols. In some embodiments, combinations of polyols with great number of hydroxyl groups may be blended with smaller quantities of polyols with less hydroxyl groups in order to produce a desired overall number of hydroxyl groups, which will react with the isocyanate.

In some embodiments, impact strength of the polyurethane composite material is greater than polyurethane composite materials comprising polyols of the same or substantially similar functionality and/or molecular weight. Although the two polyurethane compositions may comprise polyols with substantially similar average functionality and/or molecular weight, the polyurethane composition comprising polyols with substantially different functionality may exhibit improved mechanical properties such as impact strength. In some embodiments, polyurethane composite materials comprising polyols of multiple functionalities are more resistant to stress cracking.

Other embodiments of the polyurethane composite material are made from at least one polyol with a molecular weight from about 2000 to about 8000. These polyurethane composite materials exhibit an integral skin. In some embodiments, the skin is thicker. In other embodiments, the skin is less porous and harder. In some embodiments, the use of at least one polyol with a molecular weight from about 2000 to about 8000 results in the migration of the at least one polyol to migrate to the outer surface of the polyurethane composite material, thus allowing more outer skin to be formed.

In some embodiments, mixtures of two or more polyols may be used. In some embodiments, each polyol of a multi-polyol polyurethane system may be chosen for the various mechanical and chemical properties that result in the polyurethane composite produced as a result of using the polyol. For example, it is known to persons having ordinary skill in the art that polyols are often classified as rigid or flexible polyols based on various properties of the individual polyol and the overall flexibility of a polyurethane polymer produced from the respective polyols. Typically, the rigidity or flexibility of the polyurethane formed from any single polyol may be governed by one or more of the hydroxyl number, functionality, and molecular weight of the polyol. As such, one or more polyols with different characteristics may be used to control the physical and mechanical characteristics of the polyurethane composite material.

In some embodiments, the amount of rigid polyol is carefully controlled in order to avoid making the composite too brittle. In some embodiments, the weight ratio of rigid to flexible polyol ranges from about 0.5 to about 20. In other embodiments, the ratio of rigid to flexible polyol is about 1 to about 15. In other embodiments, the ratio of rigid to flexible polyol is about 4 to about 15. In other embodiments, the ratio of rigid to flexible polyol is about 3 to about 10. In other embodiments, the ratio of rigid to flexible polyol is about 6 to about 12.

If more than one polyol is used to form the polyurethane composition, mixtures of polyols can be used. In some embodiments, the polyurethane is formed by reaction of a first polyol and a second polyol. In some of these embodiments, the first polyols has a functionality of at least three and a hydroxyl number of about 250 to about 800, and more preferably about 300 to about 400. In some embodiments, the first polyol hydroxyl number is about 350 to about 410. In some of these embodiments, the molecular weight of the first polyol ranges from about 200 to about 1000. In other embodiments, the molecular weight of the first polyol ranges from about 300 to about 600. In other embodiments, the molecular weight of the first polyol ranges from about 400 to about 500. Still, in some embodiments, the molecular weight of the first polyol is about 440.

A second polyol can be used which produces a less rigid polyurethane compared to a polyurethane produced if only the first polyol is used. In some embodiments, the second polyol has a functionality of about 3. In some embodiments, the functionality of the second polyol is not greater than three. In these embodiments, the second polyol can have a molecular weight of about 1000 to about 6000. In other embodiments, the second polyol has a molecular weight of about 2500 to about 5000. In some embodiments, the second polyol has a molecular weight of about 3500 to about 5000. In some embodiments, the molecular weight is about 4800. In other embodiments, the molecular weight of the second polyol is about 3000. In some of these embodiments, the second polyol has a hydroxyl number of about 25 to about 70, and more preferably about 50 to about 60.

### Fillers

As discussed above, one or more filler materials may be included in the polyurethane composite material. In some embodiments, it is generally desirable to use particulate materials with a broad particle size distribution, because this provides better particulate packing, leading to increased density and decreased resin level per unit weight of composite. Since the inorganic particulate is typically some form of waste or scrap material, this leads to decreased raw material cost as well. In some embodiments, particles having size distributions ranging from about 0.0625 inches to below 325 mesh have been found to be particularly suitable. In other embodiments, particles having size distribution range from about 5 μm to about 200 μl, and in some embodiments, from about 20 μm to about 50 μm.

The inorganic particulate phase may be used in any suitable amount, for example between about 45 wt % to about 85 wt % of the total composition. Increasing the proportion of inorganic particulate can lead to increased difficulty in mixing, making the inclusion of a surfactant more desirable. The inorganic particulate material should have less than about 0.5 wt % water (based on the weight of the particulate material) in order to avoid excessive or uncontrolled foaming.

Suitable inorganic particulates can include ground glass particles, fly ash, bottom ash, sand, granite dust, slate dust, and the like, as well as mixtures of these. Fly ash is desirable because it is uniform in consistency, contains some carbon (which can provide some desirable weathering properties to the product due to the inclusion of fine carbon particles which are known to provide weathering protection to plastics, and the effect of opaque ash particles which block UV light, and contains some metallic species, such as metal oxides, which are believed to provide additional catalysis of the polymerization reactions. Ground glass (such as window or bottle glass) absorbs less resin, decreasing the cost of the composite.

In general, fly ash having very low bulk density (e.g., less than about 40 lb/ft³) and/or high carbon contents (e.g., around 20 wt % or higher) are less suitable, since they are more difficult to incorporate into the resin system, and may require additional inorganic fillers that have much less carbon, such as foundry sand, to be added. Fly ash produced by coal-fueled power plants, including Houston Lighting and Power plants, fly and bottom ash from Southern California Edison plants (Navajo or Mohave), fly ash from Scottish Power/Jim Bridger power plant in Wyoming, and fly ash from Central Hudson Power plant have been found to be suitable.

Some embodiments of the polyurethane composite materials additionally comprise blends of various fillers. In some of these embodiments, the polyurethane composite materials exhibit better mechanical such as impact strength, flexural modulus, and flexural strength. One advantage in using blends of such systems is higher packing ability of blends of fillers. For example, a 1:1 mixture of coal fly ash and bottom ash has also been found to be suitable as the inorganic particulate composition.

Example in Table 1: The examples below were all mixed in a thermoset aromatic polyurethane system made with Hehr 1468 polyether polyol (15% of the total weight of the non-ash portion), water (0.2%), Air Products DC-197 (1.5%), Air Products 33LV amine catalyst (0.06%), Witco Fomrez UL28 tin catalyst (0.02%), and Hehr 1426A isocyanate (15%). 1.5×3.5×24 inch boards were made.

TABLE 1

| | Ash % by | | | |
|---|---|---|---|---|
| | Weight | | | |
| | of Total | | Flexural | Flexural |
| | Resin | Density, | strength, | Modulus, |
| Coal Ash Type | System | lbs/cu ft | psi | Ksi |
| Mohave bottom ash | 65% | 70 | 1911 | 421 |
| Mohave bottom ash + | 65% | 74 | 2349 | 466 |
| Mohave fly ash (50/50) | | | | |
| Mohave bottom ash | 75% | 68 | 930 | 266 |
| Mohave bottom ash + | 75% | 79 | 2407 | 644 |
| Mohave fly ash (50/50) | | | | |
| Navajo bottom ash | 65% | 69 | 2092 | 525 |
| Navajo bottom ash + | 65% | 74 | 2540 | 404 |
| Navajo fly ash (50/50) | | | | |
| Navajo bottom ash | 75% | 70 | 1223 | 377 |
| Navajo bottom ash + | 75% | 84 | 2662 | 691 |
| Navajo fly ash (50/50) | | | | |

In some of embodiments, the polyurethane composite material comprising about 65% ash filler of which about 32.5 wt % was bottom ash and about 32.5% was fly ash had a flexural strength of at least about 2300 psi, more preferably at least about 2400 psi, and even more preferably at least about 2500 psi. In some of embodiments, the polyurethane composite material comprising about 75% ash filler of which about 37.5 wt % was bottom ash and about 37.5% was fly ash had a flexural strength of at least about 2400 psi, more preferably at least about 2500 psi, and even more preferably at least about 2650 psi.

In some of embodiments, the polyurethane composite material comprising about 65% ash filler of which about 32.5 wt % was bottom ash and about 32.5% was fly ash had a flexural modulus of at least about 400 Ksi, more preferably at least about 440 Ksi, and even more preferably at least about 460 Ksi. In some of embodiments, the polyurethane composite material comprising about 75% ash filler of which about 37.5 wt % was bottom ash and about 37.5% was fly ash had a flexural modulus of at least about 640 Ksi, more preferably at least about 660 Ksi, and even more preferably at least about 690 Ksi. In some embodiments Zeolites may be added to dry any of the ingredients, such as any polyol or any filler. The amount of zeolite may vary depending upon the moisture content of the ingredients and other factors. For example, about 0.01 wt %, about 0.1 wt %, about 1 wt %, about 2 wt %, about 5 wt %, about 10 wt %, or any amount in a range bounded by, or between, any of these percentages, may be used. The Zeolites may be left in the mix as a filler.

In some embodiments, slate dust can be added to the polyurethane composite material to provide UV protection to the polyurethane composite material. Some of these embodiments additionally comprise one or more of pigments, light stabilizers, and combinations thereof. In some embodiments, polyurethane composite materials comprising slate dust exhibit substantially improved weathering. In some embodiments, the polyurethane composite material comprises a dust. A dust may be selected from at least one of slate dust, granite dust, marble dust, other stone-based dusts, and combinations thereof. In some embodiments, the polyurethane composite material comprises about 0.2 to about 70 wt % dust. In other embodiments, the polyurethane composite materials comprise about 10 to about 50 wt % of dust. In other embodiments, the polyurethane composite materials comprise about 20 to about 60 wt % of dust. In other embodiments, the polyurethane composite materials comprise about 30 to about 55 wt % of dust. In some embodiments, dust may be added to the composite material as additional filler. In this embodiment, the filler that is not dust may be present in the composite in amounts from about 10 to about 70 weight percent and the dust may be added in amounts of about 5 to about 35 weight percent.

The following is an example of a polyurethane composite material that comprises dust. The example should be in no way limiting, as other embodiments will be readily understood by a person having ordinary skill in the art.

Example from Table 2: In a blend of Cook Composites 5180 MDI (13.1% by weight), 5205 polyol (3.91%), Dow DER (1.98%), antimony trioxide flame retardant (3.52%), with Air Products DC-197 silicone surfactant (0.23%), benzoyl peroxide (0.55%), and chipped slate (59.5%), with the added pigments, carbon black and slate dust, all acting as UV inhibitors. The light exposure was to a high fusion (UV light) chamber at AlliedSignal Aerospace. Usually a 10 minute exposure in this chamber would deeply discolor this resin system due to the yellowing of the MIDI-based ingredients in the resin system.

TABLE 2

| | | | | | | Time for |
|---|---|---|---|---|---|---|
| Sample | | | | | | Slight |
| # | | | | Green | | Change |
| (Numbers | | | Red Iron | Chromium | | in Sheen |
| are | | | Oxide | Oxide | Carbon | or Slight |
| purposely | Coal | | Pigment, | Pigment, | Black, | Discol- |
| not in | Fly | Slate | Cardinal | Cardinal | Chroma- | oration, |
| order) | Ash | Dust | Color Co. | Color Co. | Tek Co. | minutes |
| 1 | 16.7% | — | | | | 10 |
| 2 | 16.7% | — | 0.58% | | | 10 |
| 3 | 16.6% | — | | 0.58% | | 10 |
| 4 | 16.7% | — | | | 0.58% | 10 |
| 5 | — | 16.6% | | | | 20 |
| 7 | — | 16.6% | 0.58% | | | 20 |
| 8 | — | 16.6% | | 0.58% | | 20 |
| 6 | — | 16.6% | | | 0.58% | 20+ (Test |
| | | | | | | Ended) |

In the above test, clearly slate dust provided better light stability than coal ash, and the combination of slate dust plus carbon black provided the best UV resistance, and had not failed yet in the 20 minute test (the only sample to not fail). The effect of the slate dust was far more influential for UV stability then the various pigments tested, including carbon black plus fly ash.

In some embodiments, the polyurethane composite material composition comprises about 20 to about 95 weight percent of inorganic filler, which includes, for example, approximately 20, 25, 30, 35, 40, 42, 44, 46, 48, 50, 52, 54, 56, 58, 60, 62, 64, 66, 68, 70, 72, 74, 76, 78, 80, 82, 84, 86, 88, 90, 92, or 94 weight percent of filler. These amounts may be based on the total of all of the fillers, such as one or more of fly ash, dust, and fibrous material. However, the filler values may also be representative of only one type of filler, e.g., fly ash. In some embodiments, the polymeric composite material may contain the filler in an amount within a range formed by the two of the foregoing approximate weight percent. In other embodiments, the polyurethane composite material comprises about 40 to about 85 weight percent of the filler. In other embodiments, the polyurethane composite material comprises about 55 to about 80 weight percent of the filler. In other embodiments, the polyurethane composite material comprises about 65 to about 85 weight percent of the filler. In other embodiments, the polyurethane composite material comprises about 40 to about 60 weight percent of the filler. In other embodiments, the polyurethane composite material comprises about 55 to about 70 weight percent of the filler. Here, the unit “weight percent” refers to the relative weight of the filler component compared to the total weight of the composite material.

### Fibers

In some embodiments, reinforcing fibers can also be introduced into the polyol mixture prior to introduction of the isocyanate. In some embodiments, reinforcing fibers may be introduced after the at least one polyol and the isocyanate are mixed. These can include fibers per se, such as chopped fiberglass (chopped before or during mixing process such as extrusion), or fabrics or portions of fabrics, such as rovings or linear tows, or combinations of these. Typically, the reinforcing fibers range from about 0.125 in. to about 1 in, more particularly from about 0.25 in to about 0.5 in. The reinforcing fibers give the material added strength (flexural, tensile, and compressive), increase its stiffness, and provide increased toughness (impact strength or resistance to brittle fracture). Fabrics, rovings, or tows increase flexural stiffness and creep resistance. The inclusion of the particular polyurethane networks, together with the optional surfactants, and the inorganic particulate sizes used make the composite particularly and surprisingly well suited for inclusion of reinforcing fibers in foamed material, which normally would be expected to rupture or distort the foam bubbles and decrease the strength of the composite system.

In some embodiments fiber-to-resin-bonding may be improved by preheating the fibers prior to mixing them with the resins, allowing for the resins to gel quickly to the surface of the fibers, assuring the fiber is fully wetted by the resin, and resulting in higher strengths. In other embodiments the fibers may be pre-wetted by the polyol, isocyanate, or a combination thereof as they go into the extruder.

In addition to inclusion of reinforcing fibers into the polyol mixture prior to polymerization, oriented axial fibers can also be introduced into the composite after extrusion, as the polymer exits the extruder and prior to any molding. The fibers (e.g., glass strings) can desirably be wetted with a mixture of polyol (typically a higher molecular weight, rigid polyol) and isocyanate, but without catalyst or with a slow cure catalyst, or with other rigid or thermosetting resins, such as epoxies. This allows the wetted fiber to be incorporated into the composite before the newly added materials can cure, and allows this curing to be driven by the exotherm of the already curing polymer in the bulk material. In some embodiments the use of wetted fiber rovings may provide a boost in flexural strength, but may retain a low density.

Whether added before or after polymerization and/or other mixing processing such as extrusion, the dispersed reinforcing fibers may be bonded to the polymeric matrix phase, thereby increasing the strength and stiffness of the resulting material. This enables the material to be used as a structural synthetic lumber, even at relatively low densities (e.g., about 20 to about 60 lb/ft³).

According to some embodiments, many types of fibers may be suitable for use in the polyurethane composite material. In some embodiments, the polyurethane composite materials comprise at least one of basalt, Wollastinite, other mineral fibers, or combinations thereof. In some embodiments, these components may be used in place of or in combination with glass fibers

Example from Table 3: In a mixture of Hehr 1468 polyether polyol (500 grams), Hehr 1468 MDI (432 g), water (3 g), Air Products 33LV amine catalyst (1 g), Mohave coal fly ash (800 g), and the following reinforcing fibers, all made in 1.5×3.5×24 inch lumber samples:

TABLE 3

| | | Flexural | Flexural |
|---|---|---|---|
| | Fiber | Strength, | Modulus, |
| | Added | psi | Ksi |
| None | — | 1239 | 68 |
| ¼ inch long chopped | 1% | 1587 | 92 |
| fiberglass | | | |
| ¼ inch long chopped | 2.5% | 1436 | 91 |
| fiberglass | | | |
| ¼ inch long chopped | 5% | 1887 | 125 |
| fiberglass | | | |
| ¼ inch long chopped | | | |
| fiberglass | | | |
| ¼ inch long chopped | 1% | 2241 | 97 |
| basalt fiber | | | |
| ¼ inch long chopped | 2.5% | 2646 | 131 |
| basalt fiber | | | |
| ¼ inch long chopped | 5% | 3516 | 174 |
| basalt fiber | | | |
| ¼ inch long chopped | | | |
| basalt fiber | | | |
| Fiberglass + basalt | 2.5% | 2732 | 135 |
| (1.25% each) | | | |

In some embodiments, basalt fibers provide more flexural strength, and flexural modulus to the highly-filled polyurethane composite materials than fiberglass, and the combination of the two fibers gives a synergistic effect on both measured properties.

In some of embodiments, the polyurethane composite material comprising about 1.25% of chopped fiber glass and about 1.25% of basalt had a flexural strength of at least about 2650 psi, more preferably at least about 2700 psi, and even more preferably at least about 2730 psi.

Axial fibers or fabrics can also be added to the polyurethane composite material. These fiber and/or fabric typically increase the rigidity of the polyurethane composite material, and increase the mechanical strength. Using thicker fibers, rovings, tows, fabrics or rebar in the axial or stressed direction of the product can eliminate or reduce the tendency of the plastic to creep with time or higher temperature. These reinforcements also give higher initial tensile and flexural strength, and higher flexural and tensile stiffness of the polyurethane composite material. One advantage of using axial fibers or fabrics is that the fibers or fabrics are oriented in a direction that supports the polyurethane composite material. Unlike axial fibers, randomly chopped fibers are less structurally supportive.

In some embodiments, the axial fibers or fabrics may be added while dry (no resin on them). In other embodiments, the fibers or fabrics may be “wet” with resin when mixed with the polyurethane composite material. In some embodiments, the axial fibers or fabrics are added to the polyol and catalyst premix. In other embodiments, the axial fibers or fabrics are added to the isocyanate premix. Still, other embodiment may include adding the axial fibers of fabric together with a slow or delayed reaction polyol, catalyst, and isocyanate. Thus, the axial fibers can be added with multiple components of the polyurethane composite material.

In some embodiments, the axial fibers or fabrics may be added to the polyurethane composite material under tension, as is done with steel rebar in structural concrete. This provides additional strength in the tension direction, and in bending, as well as higher stiffness in the tension and bending directions.

In some embodiments, when the extrudate exits the extruder; the chopped fibers may be generally oriented in the direction of the extrudate flow. This may improve the flexural strength in the flow direction. If the extrudate is spread on the forming belts sideways or up and down, in a direction away from the axial direction, the resulting flexural strength may drop. Knowing this behavior, in some embodiments the extrudate may be fed out of shaped dies to get spreading, rather than by using the belts to squeeze the extrudate or by the foaming of the extrudate in the belts, which may give higher flexural strengths in the axial direction.

Example in Table 4: Glass and basalt fibers were implanted in a highly-filled coal ash-thermosetting polyurethane mixture while still uncured, and the fibers laid lengthwise down the urethane in a box mold, and only on the top of the board (on one face). The fibers were laid in the urethane mixture about ⅛ inch below the surface of the mix, but frequently the fibers moved during the subsequent foaming and cure in the closed box mold, and sometimes showed on the board surface.

The flexural properties were unaffected by this fiber movement. The glass fibers from rovings were 0.755 g/ft, the basalt rovings from Ahlstrom (Canada) were 0.193 g/ft. The boards were 1.5×3.5×24 inches. During flexural testing the boards were tested so that the rovings were on the tensile side of the boards (not the compression side). Some of the rovings were pre-wetted with the same resin system as in the boards, but without the coal ash filler. The resin system was: Bayer Multranol 4035 polyether polyol (16.6% by weight), Bayer Multranol 3900 polyether polyol (5.5%), Air products DC-197 silicone surfactant (0.16%), water (0.07%), Witco Fomrez UL-28 tin catalyst (0.03%), Air Products 33LV amine catalyst (0.10%), Coal fly ash (49%), Bayer MRS4 MDI isocyanate (20.4%).

TABLE 4

| | Number of | | | | | |
|---|---|---|---|---|---|---|
| | Rovings | | | | | |
| | Inserted in | | | | | |
| | Board, on | | | | | |
| | 1 face, | | Total % | | | |
| | spread | | Fiber | Board | Flexural | Flexural |
| Fiber | evenly | Wetted with | on Board | Density, | Strength, | Modulus, |
| Type | on face | Resin? | Weight | lbs/cu ft | psi | Ksi |
| None | — | — | — | 45 | 1319 | 82 |
| (Resin Alone) | | | | | | |
| Glass | 10 | No | 0.77% | 32 | 2717 | 37 |
| ″: | 10 | Yes | 1.43% | 36 | 3533 | 77 |
| ″ | 10 | Yes, but pre-cured | 0.73% | 58 | 4000 | 188 |
| ″ | 20 | Yes | 2.72% | 35 | 4356 | 84 |
| Basalt fiber | 10 | No | 0.26% | 41 | 1191 | 73 |
| ″ | 40 | No | 0.79% | 49 | 2465 | 96 |

By wetting the glass fibers with uncured resin or cured resin, the boards are considerably stronger—even stronger than basalt reinforced boards with the same weight of fiber. By wetting the glass roving with polyurethane resin, the strength of the glass roving exceeds that of the unwetted basalt fiber.

In some embodiments, glass fiber rovings may be fed into the extruder. This may allow the extruder screws to chop up the fibers, which may produce fibers having an average length of: at least about 0.01 inches, about 0.05 inches, about 0.1 inches, or about 0.12 inches; and/or up to about 0.3 inches, about 0.5 inches about 1 inch, or about 1.5 inches. Feeding the rovings near the die end of the extruder may help prevent the fibers from being too finely chopped up. The amount of fiber added may vary. For example, the fiber may be about 3% to about 8%, about 3% to about 5%, or about 5% to about 8% of the total weight of the mix.

In some embodiments, polyurethane composite materials comprising less than about 1.5 wt % of glass fiber rovings prewet with resin had a flexural strength of at least about 3500 psi and more preferably at least about 4000 psi. In embodiments wherein the prewet glass fiber rovings were procured with the polyurethane resin, the flexural strength was at least about 150 Ksi, and more preferably at least about 180 Ksi.

### Chain Extenders & Cross Linkers

In some embodiments of the polyurethane composite material, low molecular weight reactants such as chain extenders or cross linkers provide a more polar area in the polyurethane composite material. These reactants allow the polyurethane system to more readily bind the inorganic filler and/or inorganic or organic fibers in the polyurethane composite material.

In some embodiments, the polyurethane composite material comprises one or more selected from chain extenders, crosslinkers, and combinations thereof. In some embodiments, the chain extenders can be selected one or more from the group comprising ethylene glycol, glycerin, 1,4-butane diol, trimethylolpropane, glycerol, or sorbitol. In some embodiments, at least one cross linker may be used to replace at least a portion of the at least one polyol in the polyurethane composite material. In some cases, this results in reduced costs of the overall product.

In some embodiments which comprise chain extenders, the mechanical properties of the polyurethane composite material are improved. In some embodiments, chain extenders are not blocked from reacting with the isocyanate by the filler. This is due to the molecular size of the chain extenders. In some embodiments, the chain extenders result in better mechanical properties as compared to polyurethane composite materials with high filler inorganic loads, which do not use chain extenders. These mechanical properties include flexural strength and modulus, impact strength, surface hardness, and scratch resistance.

In other embodiments, polyurethane composite material comprising chain extenders traps metals and metal oxides. This is advantageous in highly filled polyurethane composite materials when the filler is coal or other ashes, including fly ash and bottom ash, which can contain hazardous heavy metals. In some embodiments, the polyurethane composite material substantially prevents leaching of heavy metals in the polyurethane composite material.

In some embodiments, a highly filled polymer composition comprising chain extenders provides faster curing and less need for post-curing of the polyurethane composite materials. In some embodiments, the chain extenders provide better water resistance for the polyurethane composite material. These chain extenders include diamine chain extenders, such as MBOCA and DETDA. However, other embodiments of the polyurethane composite material may comprise glycol extenders.

### Blowing Agents

Foaming agent may also be added to the reaction mixture if a foamed product is desired. While these may include organic blowing agents, such as halogenated hydrocarbons, hexanes, and other materials that vaporize when heated by the polyol-isocyanate reaction, it has been found that water is much less expensive, and reacts with isocyanate to yield CO₂, which is inert, safe, and need not be scrubbed from the process. In addition, CO₂ provides the type of polyurethane cells desirable in a foamed product (i.e., mostly closed, but some open cells), is highly compatible with the use of most inorganic particulate fillers, particularly at high filler levels, and is compatible with the use of reinforcing fibers. Other foaming agents may not produce the same foam structure as is obtained with water.

If water is not added to the composition, some foaming may still occur due to the presence of small quantities of water (around 0.2 wt %, based on the total weight of the reaction mixture) introduced with the other components as an “impurity.” Such water-based impurities may be removed by drying of the components prior to blending. On the other hand, excessive foaming resulting from the addition of too much water (either directly or through the introduction of “wet” reactants or inorganic particulate materials) can be controlled by addition of an absorbent, such as UOP “T” powder.

The amount of water present in the system will have an important effect on the density of the resulting composite material. This amount generally ranges from about 0.10 wt % to about 0.40 wt %, based on the weight of polyol added, for composite densities ranging from about 20 lb/ft³ to about 90 lb/ft³. However, polyurethane composite material densities may be controlled by varying one or more other components as well. In some embodiments, the overall density of the polyurethane composite material may range from about 30 lb/ft³ to about 80 lb/ft³. In some embodiments, the overall density of the polyurethane composite material may range from about 40 lb/ft³ to about 60 lb/ft³.

In some embodiments, the addition of excess blowing agent or water above what is needed to complete the foam reaction adds strength and stiffness to the polyurethane composite material, if the material is restrained during the forming of the composite material. Typically, excess blowing agent may be added to the polyol premixture. Such excessive blowing agent may produce a vigorously foaming reaction product. To contain such reaction product, a forming device that contains the pressure or restrains the materials from expanding may be used. Such forming devices are further described herein. The restraint of the material or the higher pressure created by a mold or restraining forming belts, causes higher pressure within the material which modifies the foam cell structure, thus allowing higher mechanical properties of the resulting cured material.

According to some embodiments, use of excess blowing agent in formation of the polyurethane composite material may also improves the water resistance of the polyurethane composite material. In some embodiments, use of excessive blowing agent may also increase the thickness and durability of the outer skin of the self skinning polyurethane composite material.

In some embodiments, to achieve the proper density, water blowing may be used. A water blowing agent may be low cost, non-flammable, non-toxic, non-corroding, non-volatile, and/or not reactive with components other than isocyanates. For building products with a density of about 40 pcf, the weight of water added to the total mix may be at least about 0.02% of the total mix; about 0.04% of the total mix; about 0.06% of the total mix; about 0.08% of the total mix; or to about 0.1% of the total mix; and/or up to about 0.12% of the total mix; about 0.14% of the total mix; about 0.16% of the total mix; about 0.18% of the total mix, or about 0.2% of the total mix; and/or may be about 0.1%.

In some embodiments the blowing agent for these products may be adjusted so that there is no “over-blowing.” For example, the amount of blowing agent used may be about the amount needed to fill the mold cavity. In some embodiments, the amount of blowing agent may greater than the amount needed to fill the mold cavity. This may provide increased strength in some processes, such as those where overblowing does not cause fibers to turn from axial orientation.

### Solvents

The addition of solvents to the reaction mixture may also provide certain advantages. In some embodiments of the polyurethane composite materials, solvents can be added to the polyol premix prior to or during the formation of the polyurethane. While it is described that solvents are added to the polyol premix, solvents may also be added at other stages of mixing of various components of the polyurethane composite material. In some embodiments, the solvent may be added with any one or more components of the reaction mixture which produces the polyurethane composite material.

In some embodiments, addition of a solvent to a polyol premix results in a polyurethane composite material that is more scratch and mar resistance as compared to the same polyurethane composition made without the solvent added to the polyol premix. Additional properties that result in some embodiments include a harder skin. In addition, solvents may cause a higher concentration of resin material to be in the self skinning layer, as opposed to the fillers and reinforcing fibers. In some materials, this provides a polyurethane composite material having a higher concentration of ultraviolet stabilizers, antioxidants, and other additives are closer to the outside of the composite material. In some embodiments, use of solvent produces a polyurethane composite material with an increases skin thickness. In other embodiments, the skin density may also be increased. Still, in other embodiments, the addition of solvents may decrease the interior density of the polyurethane composite material.

In some embodiments, the addition of solvent to the polyol premix substantially improves the weathering of the polyurethane composite material due to the higher density and thickness of the outer skin, which can contain more concentrated antioxidants, pigments, fillers and UV inhibitors. In other embodiments, the addition of the solvent to the polyol premix substantially prevents discoloration of the polyurethane composite material when a sample of the material is exposed to sunlight or UV radiation. In other embodiments, the addition of the solvent to the polyol premix provides a polyurethane composite material (upon mixing of the rest of the components) which has improved anti-static properties.

For example, the addition of about 2 to about 10 wt % of a solvent selected from the group consisting of a hydrocarbon solvent (pentane, hexane), carbon tetrachloride, trichloroethylene, methylene chloride, chloroform, methyl chloroform, perchloroethylene, or ethyl acetate to a polyol premix, the resulting self-skinning polyurethane composite material has a thicker skin as compared to polyurethane composite materials which are not create by the addition of a solvent to the polyol premix. As a result, the outer skin is much thicker, including greater than about 100, 200, 500, and about 1500% thicker as compared to a polyurethane made without adding solvent to the polyol premix. In some embodiments, the polyurethane composite material made by the addition of solvent to the polyol premix may have an increase outer density skin, thus making the skin harder, where the skin is greater than about 50, 75 and about 150% harder as compared to a polyurethane made without adding the solvent to the polyol premix. Furthermore, some embodiments of the polyurethane composite material have an interior density that is less than between about 10 and about 50% as compared as compared to a polyurethane made without adding the solvent to the polyol.

### Additional Components

The polyurethane composite materials can contain one or more compounds or polymers in addition to the foregoing components. Additional components or additives may be added to provide additional properties or characteristics to the composition or to modify existing properties (such as mechanical strength or heat deflection temperature) of the composition. For example, the polyurethane composite material may further include a heat stabilizer, an anti-oxidant, an ultraviolet absorbing agent, a light stabilizer, a flame retardant, a lubricant, a pigment and/or dye. One having ordinary skill in the art will appreciate that various additives may be added to the polymer compositions according to embodiments. Some of these additional additives are further described herein.

### UV Light Stabilizers, Antioxidants, Pigments

Ultraviolet light stabilizers, such as UV absorbers, can be added to the polyurethane composite material prior to or during its formation. Hindered amine type stabilizers, and opaque pigments like carbon black powder, can greatly increase the light stability of plastics and coatings. In some embodiments, phenolic antioxidants are provided. These antioxidants provide increased UV protection, as well as thermal oxidation protection.

In some embodiments, the polyurethane composite material comprises one or more selected from the group consisting of light stabilizers and antioxidants. In combination, the light stabilizers and antioxidants provide a synergistic effect of reducing the detrimental effects of UV light as compared to either component used alone in the polyurethane composite material. According to some embodiments, the effect is non-additive.

For example, in aromatic thermosetting polyurethanes, using 0.5 wt % Tinuvin 328 light absorber alone provides some resistance to UV, such as reduced yellowing, less chalking, and less embrittlement. Adding Irganox 1010 antioxidant at 0.5 wt % greatly improves the resistance to UV, and even using 0.2 wt % of each provides better stability than either of the stabilizers at 0.5 wt % alone.

Pigment or dye can be added to the polyol mixture or can be added at other points in the process. The pigment is optional, but can help make the composite material more commercially acceptable, more distinctive, and help to hide any scratches that might form in the surface of the material. Typical examples of pigments include iron oxide, typically added in amounts ranging from about 2 wt % to about 7 wt %, based on the total weight of the reaction mixture.

During outdoor weathering polyurethanes with aromatic isocyanates like TDI and MDI may tend to turn yellow. Addition of ultraviolet light stabilizers may reduce this yellowing. To further improve yellowing resistance, antioxidants may be added to prevent oxidation that may be caused by the higher heat which develop during the outdoor exposure. Hindered phenolic antioxidants, phosphites and other antioxidant types may provide better yellowing resistance when combined with the light stabilizers. In some embodiments more antioxidant, on a weight basis, than light stabilizer may be used to give enhanced resistance to color change.

### Surfactants and Catalysts

One or more catalysts are generally added to control the curing time of the polymer matrix (upon addition of the isocyanate), and these may be selected from among those known to initiate reaction between isocyanates and polyols, such as amine-containing catalysts, such as DABCO and tetramethylbutanediamine, tin-, mercury- and bismuth-containing catalysts. To increase uniformity and rapidity of cure, it may be desirable to add multiple catalysts, including a catalyst that provides overall curing via gelation, and another that provides rapid surface curing to form a skin and eliminate tackiness. For example, a liquid mixture of 1 part tin-containing catalyst to 10 parts amine-containing catalyst can be added in an amount greater than 0 wt % and below about 0.10 wt % (based on the total reaction mixture) or less, depending on the length of curing time desired. Too much catalyst can result in overcuring, which could cause buildup of cured material on the processing equipment, or too stiff a material which cannot be properly shaped, or scorching; in severe cases, this can lead to unsaleable product or fire. Curing times generally range from about 5 seconds to about 2 hours.

Some polyols may be sufficiently reactive with the isocyanate that the catalyst system may be just one catalyst, such as an amine-type catalyst. In some embodiments tin-type catalysts may not be needed. The amine may be added at a rate of at least about 0.5 pphp (parts per hundred polyol); at least about 0.6 pphp; at least about 0.7 pphp; and/or up to about 0.8 pphp; about 0.9 pphp; 0.1 pphp; and/or about 0.8 pphp.

A surfactant may optionally be added to the polyol mixture to function as a wetting agent and assist in mixing of the inorganic particulate material. The surfactant also stabilizes and controls the size of bubbles formed during foaming (if a foamed product is desired) and passivates the surface of the inorganic particulates, so that the polymeric matrix covers and bonds to a higher surface area. Surfactants can be used in amounts below about 0.5 wt %, desirably about 0.3 wt %, based on the total weight of the mixture. Excess amount of surfactant can lead to excess water absorption, which can lead to freeze/thaw damage to the composite material. Silicone surfactants have been found to be suitable for use. Examples include DC-197 and DC-193 (silicone-based, Air Products), and other nonpolar and polar (anionic and cationic) products.

In some embodiments the surfactant may be silicone based, such as siloxanes, and may be about 0.05 wt % to about 0.15 wt % of the total fill mix; about 0.05 wt % to 0.1 wt % of the total fill mix; about 0.1 wt % to 0.15 wt % of the total fill mix; or about 0.1 wt % on the total filled mix may be used.

Certain techniques may be used to slow down the gelling process. In some embodiments a catalyst may be added farther down the extruder. In some embodiments that catalyst may be added closer to the die using a separate pump with diluent (polyol) to achieve steady stream pumping. In other embodiments delayed catalysts, slow staged catalysts or H₃PO₄ may be added to the polyol. In some embodiments, lime may be added if the catalysts result in too slow tack-free time.

Sulfated fatty acids may be used in some reaction mixtures. Some fast reacting polyols may cause premature gelling and extruder die buildup when combined with isocyanates in the extruder. Addition of sulfated fatty acids to the reaction mixture may help to slow the reaction, reduce gelling, and/or reduce buildup of material on the extruder. Such slowing may be useful with highly reactive bio-based polyols and/or polyols comprising primary hydroxyl groups.

### Other Additives

In some embodiments, the filled polyurethane composite material additionally comprises at least one coupling agent. Coupling agents and other surface treatments such as viscosity reducers or flow control agents can be added directly to the filler or fiber, and incorporated prior to, during, and after the mixing and reaction of the polyurethane composite material. In some embodiments, the polyurethane composite materials comprise pre-treated fillers and fibers.

In some embodiments, the coupling agents allow higher filler loadings of an inorganic filler such as fly ash. In embodiments, these ingredients may be used in small quantities. For example, the polyurethane composite material may comprises about 0.01 wt % to about 0.5 wt % of at least one coupling agent. In some of these embodiments, the polyurethane composite materials exhibit greater impact strength, as well as greater flexural modulus and strength, as compared to those materials without at least one coupling agent. Coupling agents reduce the viscosity of the resin/filler mixture. In some embodiments, coupling agents increase the wetting of the fibers and fillers by the resin components during the mixing the components.

In other embodiments, coupling agents reduce the need for colorants by improving the dispersion of the colorants, and the break up of colorant clumps. Thus, the polyurethane composite material which comprises coupling agents and a colorant may exhibit substantially uniform coloration throughout the polyurethane composite material.

Example in Table 5: The following flow control agents were tested in a urethane polyol with a high loading of filler, such that the combination would flow through a Zahn #5 cup viscometer. The polyol was Bayer Multranol 4035 polyether used at 70 g, with 30 g of two different fillers—tested separately. The polyol+filler were hand mixed and put into the Zahn Cup with the bottom port closed with tape. When the Zahn cup was full, the tape was removed and the time for the mixture to flow out of the Cup was measured. All tests at 65° F. (18° C.). The agents were: Air Products DABCO DC197 silicone-based surfactant, Kenrich Petrochemicals Ken-React LICA 38, and Ken-React KR 55 organo-titanates, Shin-Etsu Chemical KBM-403 organo-silane.

These tests show that even 0.1% of the flow control agent on the weight of the filler can markedly improve the flow of the mixture. This flow improvement allows higher levels of filler to be used in urethane mixtures, better wetting of the filler by the polyol, and more thorough mixing of all the components. The DC-197 surfactant works well, but only at much higher concentrations.

TABLE 5

| | | Flow | Time to Flow out | % |
|---|---|---|---|---|
| | | Improver | of #5 Zahn | Improvement |
| | | Weight, | Cup, & stop | (Faster Flow) |
| Filler Type | Flow Improver | grams | dripping, seconds | Over Control |
| Ground | None (Control) | — | 60 | — |
| waste bottle | | | | |
| glass | | | | |
| Ground | KBM 403 | 0.14 | 50 | 15% |
| waste bottle | | | | |
| glass | | | | |
| Ground | KBM 403 0.51 g + | 1.34 | 53 | 18% |
| waste bottle | DC-197 0.83 g | | | |
| glass | | | | |
| Ground | KBM 403 0.15 g + | 0.75 | 56 | 7% |
| waste bottle | DC-197 0.60 g | | | |
| glass | | | | |
| Ground | DC-197 | 0.67 | 50 | 13% |
| waste bottle | | | | |
| glass | | | | |
| Cinergy fly | None (Control) | — | 46 | — |
| ash | | | | |
| Cinergy fly | KBM 403 | 0.21 | 38 | 17% |
| ash | | | | |
| Cinergy fly | KR 55 | 0.06 | 41 | 11% |
| ash | | | | |
| Cinergy fly | LICA 38 | 0.04 | 42 | 13% |
| ash | | | | |
| Cinergy fly | KBM 403 | 0.03 | 40 | 16% |
| ash | | | | |

### Ratios of the Components Used to Make the Polyurethane Composite Material

Variations in the ratio of the at least one polyol to the isocyanate have various changes on the overall polyurethane product and the process for making the polyurethane composites with high inorganic filler loads. High filler in such systems typically inhibit or physically block the reaction or action of the various polyurethane composite components, including the at least one polyol, the di- or polyisocyanate, the surfactants, flow modifiers, cell regulators and the catalysts. In addition, the heat that is released during the course of the exothermic reaction in forming the polyurethane composite is much higher in an unfilled polyurethane system. A larger isocyanate index gives higher temperature exotherms during the process of making the polyurethane composite material. By adding, 5 to 20 wt % excess, and more preferably 5 to 10 wt % excess, of the isocyanate to the otherwise chemically balanced at least one polyol that may comprise chain extenders with additional OH groups (thus, measuring the balance by the overall OH numbers).

Higher temperature exotherms result in more cross linking of the polyol and isocyanate, and/or a more complete reaction of the hydroxyl groups and isocyanate groups. In some embodiments, a higher isocyanate index also causes much higher cross link densities. In other embodiments, the higher isocyanate index provides a more “thermoset” type of polyurethane composite. In other embodiments, the higher isocyanate index provides a polyurethane with a more chemically resistant polyurethane composite material when exposed to chemicals. In some cases, these chemicals are solvents and water. In some embodiments, the higher isocyanate index provides a polyurethane composite system with a higher heat distortion temperature. The heat distortion temperature or its effects may be determined by elevated temperature creep tests, standard ASTM heat distortion testing, surface hardness variations with increased temperature, for example, in an oven, and changes in mechanical properties at increasing temperature.

Representative suitable compositional ranges for synthetic lumber, in percent based on the total composite composition, are provided below:

At least one polyol: about 6 to about 28 wt %

Surfactant: about 0.2 to about 0.5 wt %

Skin forming catalyst about 0.002 to about 0.01 wt %

Gelation catalyst about 0.02 to about 0.1 wt %

Water 0 to about 0.5 wt %

Chopped fiberglass (optional) about 0 to about 10 wt %

Pigments (optional) 0 to about 6 wt %

Inorganic particulates about 45 to about 85 wt %

Isocyanate about 6 to about 20 wt %

Axial tows (optional) 0 to about 6 wt %.

Additional components described herein can be added in various amounts. Such amount may be determined by persons having ordinary skill in the art.

### Mixing and Reaction of the Components of the Polyurethane Composite Material

The polyurethane composite material can be prepared by mixing the various components described above including the isocyanate, the polyol, the catalyst, the inorganic filler, and various other additives. In some embodiments, one or more other additives may be mixed together with the components of the polyurethane composition. One or more component resins can be heated to melt prior to the mixing or the composition may be heated during the mixing. However, the mixing can occur when each components is in a solid, liquid, or dissolved state, or mixtures thereof. In some embodiments, the above components are mixed together all at once. Alternatively, one or more components are added individually. Formulating and mixing the components may be made by any method known to those persons having ordinary skill in the art, or those methods that may be later discovered. The mixing may occur in a pre-mixing state in a device such as a ribbon blender, followed by further mixing in a Henschel mixer, Banbury mixer, a single screw extruder, a twin screw extruder, a multi screw extruder, or a cokneader.

In some preferred embodiments, the polyurethane composite material can be prepared by mixing the polyols together (if multiple polyols are used), and then mixing them with various additives, such as catalysts, surfactants, and foaming agent, and then adding the inorganic particulate phase, then any reinforcing fiber, and finally the isocyanate. While mixing of some of the components can occur prior to extrusion, all of the components may alternatively be mixed in a mixer such as an extruder.

In some embodiments, it has been found that this order of blending results in the manufacture of polyurethane composite materials suitable for building material applications. Thus, it has been discovered that the order of mixing, as well as other reaction conditions may impact the appearance and properties of the resulting polyurethane composite material, and thus its commercial acceptability.

One particular embodiment relates to a method of producing a polymer matrix composite, by (1) mixing a first polyol and a second polyol with a catalyst, optional water, and optional surfactant; (2) optionally introducing reinforcing fibrous materials into the mixture; (3) introducing inorganic filler into the mixture; (4) introducing poly- or di-isocyanate into the mixture; and (5) allowing the exothermic reaction to proceed without forced cooling except to control runaway exotherms.

The process for producing the composite material may be operated in a batch, semibatch, or continuous manner. Mixing may be conducted using conventional mixers, such as Banbury type mixers, stirred tanks, and the like, or may be conducted in an extruder, such as a twin screw, co-rotating extruder. When an extruder is used, additional heating is generally not necessary, especially if liquid polyols are used. In addition, forced cooling is not generally required, except for minimal cooling to control excessive or runaway exotherms.

For example, a multi-zone extruder can be used, with polyols and additives introduced into the first zone, inorganic particulates introduced in the second zone, and chopped fibers, isocyanate, and pigments introduced in the fifth zone. A twin screw, co-rotating, extruder (e.g. 100 mm diameter, although the diameter can be varied substantially) can be used, with only water cooling (to maintain substantially near room temperature), and without extruder vacuum (except for ash dust). Liquid materials can be pumped into the extruder, while solids can be added by suitable hopper/screw feeder arrangements. Internal pressure build up in such an exemplary arrangement is not significant.

In some embodiments the highly-filled mixture may be mixed with a twin screw, self-wiping, co-rotating extruder, or with a mix-head. In some embodiments the mix head may have feeds for the filler and fibers.

Although gelation occurs essentially immediately, complete curing can take as long as 48 hours, and it is therefore desirable to wait at least that long before assessing the mechanical properties of the composite, in order to allow both the composition and the properties to stabilize.

As explained above, the composite material may be advantageously used in structural products, including synthetic lumber. The synthetic lumber may be formed in a batch, semibatch, or continuous fashion. For example, in continuous operation, polymerized (and polymerizing) material leaving the extruder (after optional incorporation of post-extruder fibers, tows, or rovings) is supplied to a forming system, which provides dimensional constraint to the material, and can be used to pattern the surfaces of the resulting synthetic lumber with simulated wood grain or other designs, in order to make the material more commercially desirable. For example, a conveyor belt system comprising 2, 4, or 6 belts made from a flexible resin having wood grain or other design molded therein can be used. Desirably, the belts are formed from a self-releasing rubber or elastomeric material so that it will not adhere to the polymer composite. Suitable belt materials include silicone rubber, oil impregnated polyurethane, or synthetic or natural rubbers, if necessary coated with a release agent, such as waxes, silicones, or fluoropolymers.

Representative suitable compositional ranges for synthetic lumber, in percent based on the total composite composition, are provided below:

| | |
|---|---|
| Rigid polyol | about 6 to about 18 wt % |
| Flexible polyol | 0 to about 10 wt % |
| Surfactant | about 0.2 to about 0.5 wt % |
| Skin forming catalyst | about 0.002 to about 0.01 wt % |
| Gelation catalyst | about 0.02 to about 0.1 wt % |
| Water | 0 to about 0.5 wt % |
| Chopped fiberglass | 0 to about 10 wt % |
| Pigments | 0 to about 6 wt % |
| Inorganic particulates | about 60 to about 85 wt % |
| Isocyanate | about 6 to about 20 wt % |
| Axial tows | 0 to about 6 wt %. |

Some embodiments can be further understood by reference to the following non-limiting examples.

### Example 1

A polymer composite composition was prepared by introducing 9.5 wt % rigid polyol (MULTRANOL 4035, Bayer), 0.3 wt % rubber polyol (ARCOL LG-56, Bayer), 0.3 wt % surfactant/wetting agent (DC-197, Air Products), 0.005 wt % film forming organic tin catalyst (UL-28/22, Air Products), 0.03 wt % amine gelation catalyst (33LV, Air Products), and 0.05 wt % water as foaming agent to the drive end of a 100 mm diameter twin screw co-rotating extruder with water cooling to maintain room temperature. At a point around 60% of the length of the extruder, 4.2 wt % chopped glass fibers (Owens Corning) with ¼ to ½ inch lengths were added, along with 4.0 wt % brown pigment (Interstar), 74 wt % fly ash (ISG), and 9.6 wt % isocyanate (MONDUR MR Light, Bayer). The extruder was operated at room temperature (75° F.), at 200 rpm for one hour. Following extrusion, 0.4 wt % of a resin mixture of rubbery polyol (ARCOL LG-56, Bayer), and isocyanate (MONDUR MR Light, Bayer) were added to the surface of the extruded material to provide a bonding adhesive for glass tows. The glass tows (Owens Corning) ¼ to ½ inch length were added in an amount of around 2 wt % to provide added rigidity, and were added just below the surface of the material produced by the extruder.

The resulting composite material was particularly useful as synthetic decking material.

### Example 2

In a batch reactor, 16.4 wt % rigid polyol (Bayer 4035) was combined with 1.9 wt % flexible polyol (Bayer 3900), 0.2 wt % surfactant (DC-1 97), water, 3.2 wt % pigments, 0.0001 wt % UL-28 organic tin catalyst, and 0.1 wt % 33LV amine catalyst, and thoroughly mixed for 1 minute. 31.5 wt % Wyoming fly ash was then added and mixed for an additional 1 minute. Finally, 17.3 wt % isocyanate (1468A, Hehr), 0.9 wt % chopped brown fiber, 3.5 wt % chopped glass (0.25 in. diameter), and an additional 25.2 wt % Wyoming fly ash were added and mixed for 30 seconds. The resulting material had a resin content of 36%, a ratio of rigid to rubbery polyol of 90%, a solids content of 64%, a 10% excess isocyanate content, and a fiber content of 4.4%, all by weight based on the total composition unless noted otherwise. The resulting material was suitable for forming synthetic lumber boards.

### Example 3

In a batch reactor, 16.4 wt % rigid polyol (Bayer 4035) was combined with 1.9 wt % flexible polyol (Bayer 3900), 0.2 wt % surfactant (DC-197), water, 3.2 wt % pigments, 3.5 wt % chopped glass (0.25 in. diameter), around 0.4 wt % Mohave bottom ash, 0.0001 wt % UL-28 organic tin catalyst, and 0.1 wt % 33LV amine catalyst, and thoroughly mixed for 1 minute. 31.5 wt % Wyoming fly ash was then added and mixed for an additional 1 minute. Finally, 17.3 wt % isocyanate (1468A, Hehr), 0.9 wt % chopped brown fiber, and an additional 25.2 wt % Wyoming fly ash were added and mixed for 30 seconds. The resulting material had a resin content of 36%, a ratio of rigid to rubbery polyol of 90%, a solids content of 64%, a 10% excess isocyanate content, and a fiber content of 4.4%, all by weight based on the total composition unless noted otherwise. The resulting material was suitable for forming synthetic lumber boards.

For each of Examples 2 and 3, water was added in amounts shown below (in percent based on total polyol added); physical properties of the resulting material were tested, and the results provided below. The 200 lb impact test was conducted by having a 200 lb man jump on an 18 inch span of synthetic lumber board, 2×6 inches. supported above the ground from a height of about 1 ft in the air, and evaluating whether the board breaks.

| | | | | | | | | 200 lb |
|---|---|---|---|---|---|---|---|---|
| | H₂O | | Break | 100 psi | Hardness | Flexural | Flexural | impact |
| | (% of | Density | Strength | Deflection | (Durometer | Strength | Modulus | test |
| Example | polyol) | (lb/ft³) | (psi) | (in) | C) | (psi) | (psi) | (P/F) |
| 2 | 0.10 | 63 | 730 | 0.15 | 62 | 3129 | 118,331 | P |
| 2 | 0.23 | 59 | 650 | 0.15 | 57 | 2786 | 118,331 | P |
| 2 | 0.40 | 47 | 450 | 0.15 | 52 | 1929 | 118,331 | F |
| 3 | 0.10 | 63 | 810 | 0.15 | 62 | 3472 | 118,331 | P |

### Example 4

Fiberglass rovings (Ahlstrom, 0.755 g/ft) or brown basalt rovings (0.193 g/ft) were positioned in a 24 inch mold for 2×4 inch synthetic lumber, and stabilized to limit movement relative to the mold surface (about 0.125 in. in from the mold surface) and to keep them taut. The rovings were applied dry, coated and pre-cured with the synthetic lumber composition (minus ash and chopped glass), and wet with a mixture of 49 wt % rigid polyol (MULTRANOL 4035), 0.098 wt % surfactant (DC-197), 0.20 wt % amine catalyst (33LV), and 49.59 wt % isocyanate (Hehr 1468A).

To the mold was added a synthetic lumber mixture, formed by combining 16.6 wt % rigid polyol (MULTRANOL 4035), 5.5 wt % flexible polyol (MULTRANOL 3900), 0.16 wt % surfactant (DC-197), 0.07 wt % water, 3.7 wt % pigments, 0.003 wt % organic tin catalyst (UL-28, Air Products), and 0.1 wt % amine catalyst (33LV), and mixing for 1 minute, then adding 26.4 wt % Wyoming fly ash, mixing for 1 minute, and finally adding 20.4 wt % isocyanate (MRS4, Bayer), 1.1 wt % chopped brown fiber, 3.4 wt % chopped 0.25 in. fiberglass, and 22.5 wt % Wyoming fly ash, and mixing for 30 seconds.

The physical properties of the resulting boards were assessed, and are indicated below. Control boards were also prepared to different densities, and their physical properties evaluated as well. The axially oriented rovings greatly increased flexural strength, with little added weight. The rovings tend to have a more pronounced strengthening effect as the load on the material is increased.

| | Number | | | Flexural | Flexural | Flexural |
|---|---|---|---|---|---|---|
| Roving | of | Roving | Density | strength | Modulus @ 100 | Modulus @ 200 |
| type | rovings | coating | (lb/ft³) | (psi) | psi (Ksi) | psi (Ksi) |
| Basalt | 10 | Dry | 41 | 1191 | | |
| Fiberglass | 10 | Pre-cured resin | 58 | 4000 | | |
| Fiberglass | 10 | Dry | 62 | 5714 | | |
| Basalt | 40 | Dry | 49 | 2465 | | |
| Basalt | 40 | Dry | 31 | 1650 | | |
| Fiberglass | 10 | Dry | 32 | 2717 | | |
| Fiberglass | 10 | Wet | 36 | 3533 | | |
| Fiberglass | 5 | Wet | 36 | 2410 | | |
| Fiberglass | 15 | Wet | 38 | 4594 | | |
| Fiberglass | 20 | Wet | 35 | 4356 | | |
| None | | | 55 | 1808 | | |
| None | | | 66 | 4724 | | |
| None | | | 68 | — | | |
| None | | | 59 | 2568 | | |
| None | | | 45 | 1319 | | |
| None | | | 35 | 1174 | | |
| None | | | 41 | 746 | | |

The synthetic lumber produced was found to have good fire retardant properties, achieving a flame spread index of 25, and to produce only small quantities of respirable particles of size less than 10 μm when sawn. It provides excellent compressive strength, screw and nail holding properties, and density. Extruded composite described herein generally provides mechanical properties that are even better than those provided by molded composite.

### Extrusion

As discussed above, particular methods related to extruding polyurethane composite materials. One particular method includes extruding the polyurethane composite materials as described herein through an extruder having various segments and multiple screw elements

Referring to FIG. 4, one example of an extruder suitable for forming polyurethane composite materials may include up to nine barrel segments. As shown, each barrel segment includes at least one screw element. In addition, some or all of the barrel segments have a material input port.

In a first segment of the extruder, the at least one polyol may be introduced to the extruder. In some embodiments, the at least one polyol may include a blend of one or more polyols. Additionally, the at least one polyol may be blended with one or more of the catalyst, surfactants, blowing agents and other components described herein. In some embodiment, each components may be added individually or together. In some embodiments, the components are preblended prior to introduction to the extruder. As shown in FIG. 4, a first segment of the extruder includes a transport screw. As the transport screw is driven, the at least one polyol and optional other components are transported by the screw toward the output end of the extruder

In a second segment of the extruder, inorganic filler material such as ash may be introduced to the extruder. The inorganic filler material is blended with the components from the first segment. As shown in FIG. 4, a second segment of the extruder includes a transport screw. The transport screw may further transfer the components from the first and second segments of the extruder toward the output end of the extruder. As the first and second segment include a transport screw, the first and second segment may be classified as a first conveying section.

Components inputted in a first or second segment may be transferred to a third segment of the extruder by the screw. In a third segment of the extruder, previously inputted components may be mixed further by slotted screws. A third segment may also include lobal screws. In some embodiments, the mixing provides a substantially uniform mixture of one or more of least one polyol, at least one catalyst, a surfactant, an optional blowing agent, pigment, and filler. These components experience more shearing forces created by the slotted screw. The previous introduced components may then be further transferred toward the output end of the extruder. In some embodiments, the components are transferred to a fourth segment of the extruder. As shown in FIG. 4, a fourth segment may contain one or more of lobal and slow transport screws. As the third and fourth segments may contain mixing elements, such segments may be classified as a first mixing section. This screw provides additional mixing to provide a more homogenous mixture of the components. This screw also may provide good wetting of the fillers and fibers. It has been discovered that lobal screws provide a more homogeneous mixture of the previously introduced components.

In some embodiments, the isocyanate components may be introduced subsequent to the polyol component. As shown in FIG. 4, the isocyanate component (monomeric or oligomeric di- or polyisocyanate) is introduced in a subsequent segment of extruder related to the segment in which the at least one polyol was introduced. More specifically, the isocyanate component is introduced in a fifth segment of the extruder. In some embodiments, a reaction may begin to occur between the at least one polyol and the at least one isocyanate. However, a delayed action catalyst may used to substantially prevent overreaction of the components until the composite material has exited the extruder. As the reaction between the at least one polyol and the at least one isocyanate is exothermic, cooling may be required. Cooling may also be required in subsequent barrel segments. In previous barrel segments, cooling is generally not required as no reaction has occurred. However, cooling may be provided to previous barrel segments according to some embodiments.

As shown in FIG. 4, the fifth segment may contain a screw element such as a transport screw element. The transport screw may provide mixing of the isocyanate and previously added components including at least one polyol and the inorganic filler. To allow substantially thorough mixing of these components, one or more mixing screw elements may be used. The transport screw of the fifth segment may transfer the at least one polyol, the inorganic filler, and the isocyanate (and optional other additives) to a subsequent segment. Such subsequent segment may be all or a portion of a second mixing section. In some embodiments, these components are transferred to a sixth segment as shown in FIG. 4.

In a sixth barrel segment or in the second mixing section, a reverse screw provides a substantial amount of mixing to the previous added components of the composite mixture. In some embodiments, substantial shearing is provided to the composite mixture. As a reverse screw has negative pitch, the components of the composite material may be block from being transferred through such a segment until sufficient shearing forces and pressure allow the mixture to pass through this segment. In some embodiments, the reverse screw is configured to block the mixture back to a subsequent segment or section. For example, the entire mixture may be blocked to one or more of the first segment, second segment, third segment, fourth segment, or fifth segment. In some embodiments, the components of the mixture are blocked to one or more of the first conveying section, second conveying section, or the first mixing section. Such shearing together with the exothermic reaction of the polyol and the isocyanate may require cooling in the segment or section.

In an alternative embodiment, a sixth segment may contain a transport screw and the previously added components may be further transferred toward the output end of the extruder. As shown in FIG. 4, substantial mixing by a reverse screw may occur in a subsequent segment (e.g., an eighth or ninth segment) subsequent to introduction of one or more other components such as fibrous materials.

Vents may be disposed on either side of the second mixing section. As large amounts of mixing may release entrained air in the one or more components of the polyurethane composite mixture, such air must be released. Additionally, gas produced by the blowing agent may be required to be released. In some embodiments, a vacuum may be used to remove the entrained air and/or gas from the blowing agent. In some embodiments, the removed air or gas results in the formation of a more dense and uniform polyurethane composite material.

In optional embodiments, fiber rovings may be added to the composite mixture in a subsequent segment. This segment may be found in a third conveying section. As shown in FIG. 4, fibrous material may be introduced in a seventh segment of the extruder. Such a segment may also contain a transport screw. In particular embodiments, the transport screw may be a fast transport screw. In some embodiments, the fast transport screw has fewer screw threads per unit of length as compared to a slow transport screw. The transport screw of the segment may introduce, chop up, and mix the fiber rovings.

In subsequent segments, the mixture may be further mixed and transported toward the output end of the extruder. Such subsequent segments may constitute a second or third mixing section, depending on the embodiment as discussed above. For example, in an eighth segment, lobal screws may provide further mixing to the composite mixture. In addition, a reverse screw may be provided in this or subsequent segments to provide substantial mixing and/or shearing of the components of the composite mixture.

As mentioned above a mixing section adjacent to the output end of the extruder may include one or more reverse screws and lobal screws. In some embodiments, a reverse screw is in the last segment of the extruder. In some embodiments, the reverse screw is a reverse slotted screw. As enough shearing forces and/or pressure transfer the mixture past the reverse screw, the mixture is extruded through a die.

In some embodiments, the extruder has a L/D of about 10 to about 40. In some embodiments, the extruder has a L/D of about 10 to about 15. In some embodiments, the extruder has a L/D of about 20 to about 40. In some embodiments, the extruder has a L/D that is greater than about 24. In some embodiments, the extruder may operate from between about 200 to about 2000 rpm.

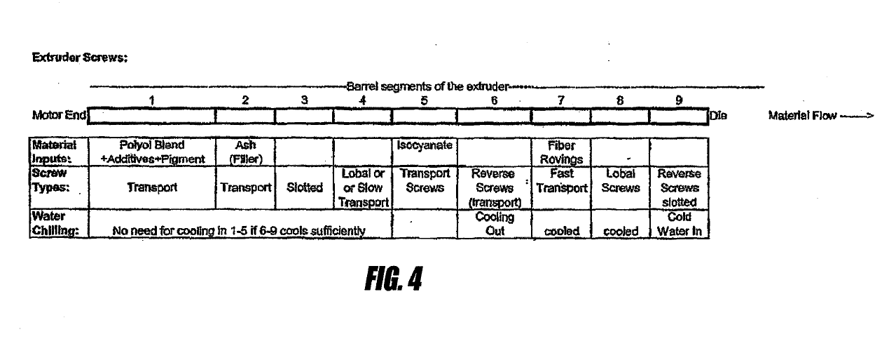

FIG. 5 represents one configuration of an extruder for the introduction of the components materials as described above. This extruder includes a first conveying section C₁, a first mixing section M₁, a second conveying section C₂, and a second mixing section M₂. A feed end is shown on the right and an output end on the left.

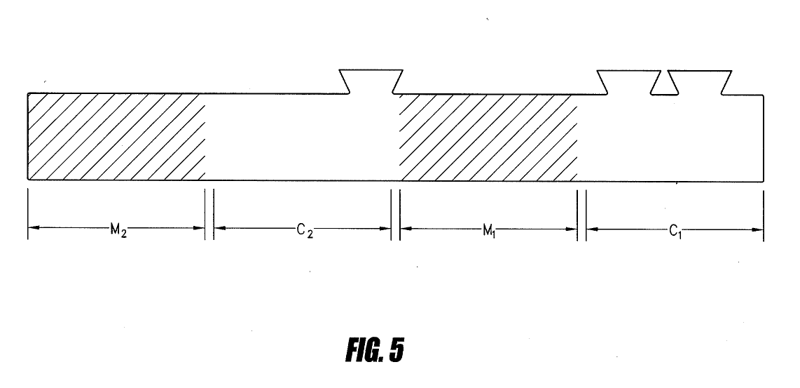

FIG. 6 represents one configuration of an extruder for the introduction of the components materials as described above. This extruder includes a first conveying section C₁ and a first mixing section M₁. A feed end is shown on the right and an output end on the left.

In accordance with some embodiments, foaming of the polyurethane composite materials occurs after the die. In some embodiments, some foaming and reaction of the composite mixture may occur prior to or during extrusion.

Other alternatives may be used when providing the mixed polyurethane composite material. For example the extruder may have more than or less than nine barrel segments. In some embodiments, certain types of screws can be replaced by a different type of screw. These variations should be apparent to a person having ordinary skill in the art.

In some embodiments a vacuum may be added to the extruder to vent out air, reducing the bubbles and blisters. In other embodiments bubbles may be eliminated by the addition of surfactant at the end of extrusion. In some embodiments moving the belts at the same speed when the extrudate is leaving the die may reduce edge scalloping. In other embodiments increasing the diameter of the die or squishing the extrudate on the belt may reduce scalloping.

In some embodiments the water level may be kept high enough to fill the belt. In some embodiments belt speeds can be altered to control wandering or squiggling as extrudate hits the belt. In some embodiments the belts can run hot, but in some embodiments the belts may run cooler allowing for more flow of extrudate on wide belts.

Solid, semi-solid, or viscous liquid forms of composite materials described herein may be dispensed into a mold by forcing the materials through a hole, such as extruding the material through a die, forcing the material through a hole in a sprayer, or a similar process. Spraying may be carried out by creating a pressure in a chamber that forces the solid material through a hole. Suitable sprayers may include the ESCO Model FFH Mix Head, the CANNON Trio Mix Head, or similar devices. The materials may also be mixed in a traditional mixer, similar to a paint mixer, and poured into a mold without dispensing the material through a hole.

### Forming

In some embodiments, the process of forming the highly filled polyurethane composite material comprises providing the components of the polyurethane composite material, mixing the components together, extruding the components through a die, adding any other additional components after the extrusion, and forming a shaped article of the polyurethane composite material. As the polyurethane composite material exits the die, the composite material may be placed in a mold for post-extrusion curing and shaping. In some embodiments, the composite material is allowed to cure in a box or bucket.

In some embodiments the formation of the shaped articles comprises injecting the extruded polyurethane composite material in a mold cavity and curing the shaped article. However, some embodiments require that the extruded polyurethane composite material be placed in a mold cavity secured on all sides, and exerting pressure on the polyurethane composite material. In some of these embodiments, the polyurethane composite material will be foaming or will already be foamed. However, it is preferred that the material is placed under the pressure of the mold cavity prior to or at least during at least some foaming of the polyurethane composite material.

A shaped article can be made using the polyurethane composite materials according to the foregoing embodiments. In some embodiments, this article is molded into various shapes. In some embodiments, the polyurethane composite material is extruded, and then injected into a continuous production system. Suitable systems for forming the composite materials of some embodiments are described as follows:

### System Utilizing Up to Six Endless Belts

For clarity of understanding, some embodiments will be described herein with respect to a single apparatus. It should be understood, however, that the invention is not so limited, and the system and method of the invention may involve two or more such systems operated in series or in parallel, and that a single system may contain multiple sets of belts, again operated in series or in parallel.

### Flat-Belted Conveyor Channel

Each set of opposed flat belt conveyors are oriented so that their bearing surfaces face each other. One set of opposed flat belts can be thought of as “upper” and “lower” belts, although these descriptors are not limiting, nor do they require that the two opposed belts be horizontal. In practice, however, one set of opposed belts (the upper and lower belts) will be substantially horizontal. These belts can define the upper and lower surfaces of a mold cavity (when the device is operated in four-belt mode), or may provide support and drive surfaces for a set of opposed profile mold belts (when the device is operated in six-belt mode). The remaining set of opposed flat belts are disposed substantially orthogonal to the first set. As used herein, the term “substantially orthogonal” means close to perpendicular, but allowing for some deviation from 90° resulting from adjustment of the device, variations from level in the manufacturing floor, etc. This substantially orthogonal arrangement is accomplished in two basic configurations.

The first exemplary configuration involves disposing the flat bearing surfaces of the second set of belts along the sides of the space formed by the first set of belts, thereby forming an open-ended mold cavity that is enclosed by flat belts, and having a length corresponding to the length of the “side” belts. This configuration is illustrated in FIG. 5. FIG. 7A provides a top view, FIG. 7B a side view, and FIG. 7C an end view, of a system 2 having upper flat belt 4, lower flat belt 4′ upper profile mold belt 6, lower profile mold belt 6′, and side belts 8 and 8′. These side belts extend longitudinally approximately the same distance as the upper and lower flat belts, providing a mold cavity that is supported from the side over virtually the entire length of the profile mold belts. Profile mold belts 6 and 6′ are maintained in tension by tensioning rolls 10. Flat belts 4 and 4′ are powered by driven rollers 12 and 12′.

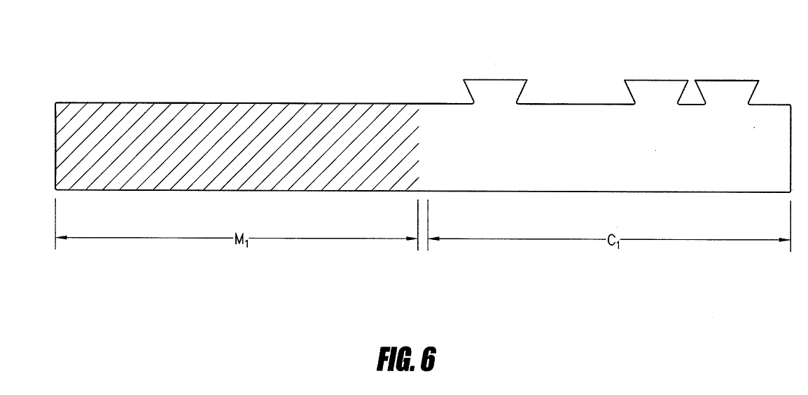

The arrangement of belts and the corresponding rollers for this exemplary configuration can be seen in more detail in FIG. 8, which is a partially expanded view, wherein the upper flat belt 4, upper profile mold belt 6, and corresponding supports and rollers 10 and 12, have been lifted away from the remainder of the system for ease of visualization. Side belts 8, 8′ are supported by side belt supports 14 and 14′, and can run on side belt support rollers 16, 16′. These side belt support rollers are powered, or unpowered, as illustrated in FIG. 8. In addition, upper and lower flat belts 4 and 4′ are supported by rigid supporting surfaces, such as platens 18, 18′.

As mentioned above, each flat belt is supported by a slider-bed or platen comprised of a rigid metal plate or other rigid supporting surface, if the length of the belt makes such support necessary or desirable. Generally, in order to provide sufficient curing time for filled polyurethane foams, a support surface is desirable but not required. The surface of the slider-bed in some embodiments has a slippery coating or bed-plate material attached or bonded to it (for example, ultra-high molecular weight polyethylene, PTFE, or other fluoropolymer). Also, the belt has a slippery backing material (for example, ultra-high molecular weight polyethylene, PTFE or other fluoropolymer) to reduce friction between the bed and moving belt in an exemplary embodiment.

To further reduce friction and enhance cooling of the belts and conveyor machinery, the slider-beds and attached slippery surface material of a conveyor has a plurality of relatively small holes drilled through the surface These holes are in fluid communication with a source of compressed gas, such as air. As an example, a plenum chamber is provided behind each slider bed, which is then connected to a source of pressurized air. Pressurized air fed into each plenum passes through the holes in the bed, and provides a layer of air between the bed and the adjacent belt. This air film provides lubrication between the bed and adjacent belt as shown in FIG. 8, where compressed air is supplied to the plenums through openings 20, 20′ The air fed into the plenums has a pressure higher than the foaming pressure of the product to be useful in reducing operating friction. In some embodiments, shop air or high-pressure blowers are used to provide the pressurized air to feed the plenums.

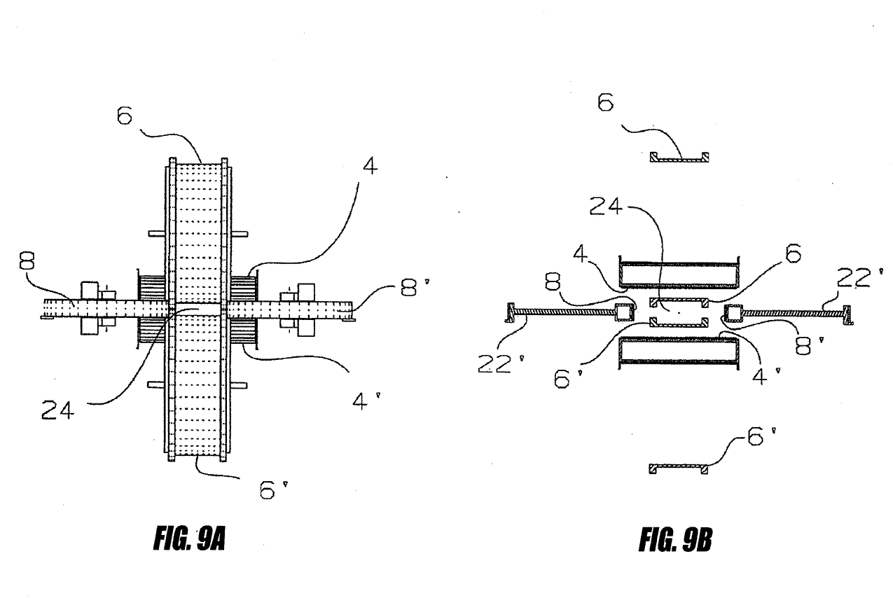

In a more particular exemplary embodiment, shown in FIG. 12, air supply plenums are also used to provide support to the sides of the mold belts, either directly (shown) or through side belts (not shown). In FIG. 12, flat belts 4 and 4′ are supported by upper and lower air supply plenums 32 and 32′, respectively. Areas of contact between the belts and the plenums are prepared from or coated with a low-friction substance, such as PTFE, or are lubricated to lower the friction between the belts and the supporting surfaces. Pressurized air 34 is supplied to these plenums through openings 36, 36′, and exits the plenums through openings 38, 38′, where it flows under and supports flat belts 4, 4′, which in turn support the upper and lower surfaces of profile mold belts 6, 6′. In addition, pressurized air 40 enters side plenums 42, 42′ through openings 44, 44′. The air leaves these side plenums through opening 46, 46′, and flows against and supports the sides of profile mold belts 6, 6′. This support can result either from the air flow impinging directly on the sides of the mold belts, or from air flow impinging on the surfaces of side belts that in turn press against the sides of the profile mold belts. The profile mold belts, in turn, provide support to the material being formed, 48.

The flat-belts are powered and driven at matching speeds with respect to one another. The matched speeds are achieved, in some embodiments, by mechanical linkage between the conveyors or by electronic gearing of the respective motors. Alternatively, an as illustrated in FIGS. 1 and 2, only two flat belts are driven (for example, the two opposing belts with greater contact area, which are typically the upper and lower belts) with the remaining two flat belts (for example, the side belts) un-driven and idling. The flat-belts form a relatively rigid moving channel through which contoured mold-belts and/or forming product is moved and contained.

The driven flat-belts utilize known driven roller technologies, including center-drive pulley mechanisms, whereby more than 180° of contact is maintained between each conveyor's driving pulley and belt, increasing the amount of force that may be delivered to the belt.

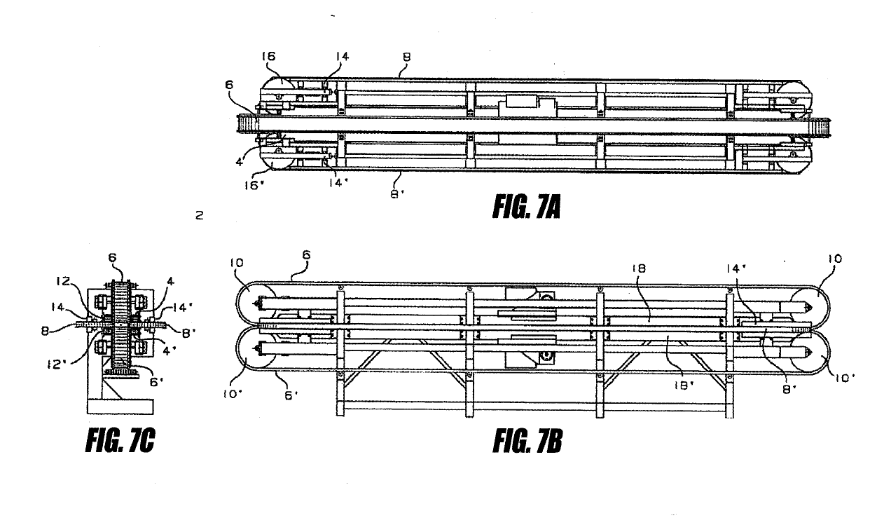

In another exemplary configuration, the side flat belts are disposed substantially orthogonal relative to the upper and lower flat belts such that their bearing surfaces face each other, and are in a plane substantially perpendicular to the plane of the bearing surfaces of the upper and lower belts, as illustrated in FIG. 9. FIG. 9A is an end view with the corresponding drive and support apparatus removed for ease of viewing. FIG. 9A shows side flat belts 8 and 8′ disposed between upper flat belt 4 and lower flat belt 4′. An expanded sectional view of this exemplary configuration is provided in FIG. 9B. The frames 22 and 22′ supporting the side belts are restrained in such a way as to allow the position of the side flat belts to be adjusted laterally providing the desired degree of pressure against the sides of profile mold belts 6 and 6′ or to accommodate mold belts of alternate widths. This configuration provides a relatively short, but highly contained mold cavity 24.

### Mold-Belts

The contoured mold-belts are relatively thick belts with a rubbery face material attached to a fiber-reinforced backing or carcass as shown in FIG. 10. The profile mold belt 6′ is constructed to contain an inner surface 25, that defines part of mold cavity 24. It also has side surfaces 26, which contact side flat belts 8, 8′, and outer surface 30, which contacts the inner surface of flat belt 4′. The fiber-reinforcement 28 in the backing of the belts will provide the strength and rigidity in the belt while the face material has the profile, surface features, and texture that is molded into the product. The desired mold profile, surface features, and texture are machined, cut, bonded, and/or cast into the surface of the mold-belts. The mold cavity created by the mold belts has a constant, irregular, and/or segmented cross section. Multiple cavities can be incorporated into a single set of mold belts. Suitable mold surface materials include, but are not restricted to Nitrile, Neoprene, polyurethane, silicone elastomers, and combinations thereof. Suitable fibers for reinforcing the profile mold belt include cotton, aramid, polyester, nylon, and combinations thereof.

Each profile mold-belt travels beyond the ends of the surrounding flat-belt conveyors to a separate set of large pulleys or rollers that maintain tension and the relative position of each belt. In some embodiments, the mold-belts are un-powered, functioning as idlers or slave belts to the powered flat belts behind them. In some embodiments, the mold belts are separately powered.

The temperature of the mold belts can be adjusted during production in the event that additional heat is needed or surplus heat is to be removed. If the temperature of the belt surface is adjusted, temperature controlled air is blown onto the belt surfaces as the belts exit the flat-belted conveyor enclosure and follow their return path to the entrance of the forming machine. In some embodiments, infrared or other radiant heaters are used to increase the temperature of the mold surface. In some embodiments, temperature controlled air or other fluid is routed through the conveyor frames to maintain predetermined process temperatures.

### Orientation

As described above, the exemplary orientation of the forming system is for the contact surface between mold-belts to be horizontal. The gap between the upper and lower flat-belted conveyors (those conveyors adjacent to the backs of the mold-belts), can be precisely maintained such that the pair of mold-belts pass between them without being allowed to separate (presenting a gap to the molding material) and without excessively compressing the mold-belt shoulders or side walls. In the exemplary embodiment, the upper conveyor is removable while not in operation in order to permit replacement of the mold belts.

### Side Conveyors

The flat-belted conveyors adjacent to the sides of the profile mold belts provide structural support for the sides of the mold cavity, resist any deflection of the sides due to foaming pressure, and maintain alignment of the mold-belts. These side-supporting conveyors permit the use of thinner mold-belt sidewalls, which reduces the cost and mass of the mold-belts. The use of these side-supporting conveyors also permits the molding of deeper product cross sections without requiring excessive mold-belt widths.

### System Versatility

An exemplary configuration for the flat-belted conveyors is for the top and bottom conveyors to be wide, with the side conveyors sized to fit between the belts of the upper and lower conveyors in such a way that the surface of the upper and lower (wide) belts approach or make contact with the edges of the side belts. The frames, pulleys, and slider-beds of the side conveyors are slightly narrower than their respective belts to avoid contact with the upper and lower belts. A cross section of this exemplary configuration is shown in FIG. 9B as described above. With this orientation, the gap between the side conveyors is adjustable in order to accommodate wider or narrower pairs of mold-belts. This configuration permits a range of product widths to be produced by the same forming machine. Only the mold-belt set is replaced in order to produce product of a different width.

To further increase the versatility of the forming machine, the side conveyor belts, pulleys, and slider beds are replaced with taller or shorter components and the gap between upper and lower conveyors adjusted accordingly. This feature permits the forming machine to accommodate mold-belts of various depths to produce thicker or thinner cross sections.

### Four-Belt Mode

The specific exemplary embodiments described above with respect to the drawings generally relate to configuration of the system in “six belt mode.” In other words, an upper and lower flat belt, two side flat belts, and an upper and lower profile mold belt. The mold belts permit surface details, corner radii, irregular thicknesses, and deeper surface texture to be molded into the continuously formed product. However, for rectangular or square cross-sectioned products that do not require corner radii, deep texture, or localized features, the forming system is used without mold-belts, and operated in “four belt mode.” In this exemplary operating configuration the four flat belts make direct contact with the moldable product and permit the product to form within the flat-sided cavity. When the forming system is used in this configuration it is important that the upper and lower belts maintain contact with the edges of the side belts to prevent seepage of the material between adjacent belts. In order to produce thicker or thinner products in “four belt mode” the side flat belts, adjacent slider beds, and side belt pulleys are replaced with components in the target thickness. The gap between side belts is adjusted to accommodate the target width. Using this approach a large variety of four-sided cross-sections can be produced by the same machine without the added cost of dedicated mold-belts.

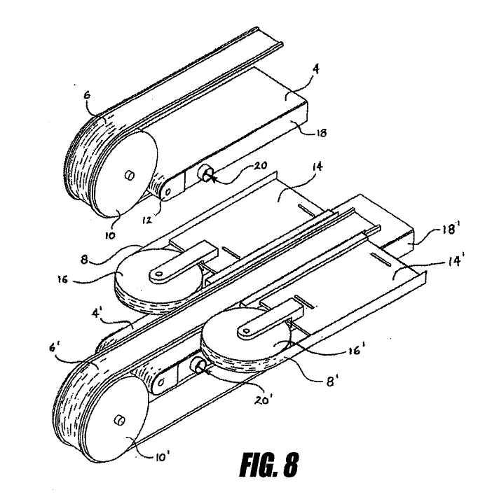

The four belt configuration is illustrated in FIG. 11. The sectional portion of the drawing shows that the mold cavity 24 is formed by the surfaces of upper and lower flat belts 4, 4′ and the surfaces of side belts 8, 8′.

### Fabrication

The forming system structure may be fabricated using metal materials and typical metal forming and fabricating methods such as welding, bending, machining, and mechanical assembly.

The forming system is used to form a wide variety of moldable materials, and has been found to be particularly suitable for forming synthetic lumber.

Although the descriptions above describe many specific details they should not be construed as limiting the scope of the invention or the methods of use, but merely providing illustration of some of the presently preferred embodiments of the invention.

### Continuous-Forming Apparatus for Three-Dimensional Foam Products

The presently preferred embodiments will be best understood by reference to the drawings, wherein like parts are designated by like numerals throughout. It will be readily understood that the components of the present embodiments, as generally described and illustrated in the figures herein, could be arranged and designed in a wide variety of different configurations. Thus, the following more detailed description of the embodiments of the continuous forming apparatus, as represented in FIGS. 1 through 18, is not intended to limit the scope of the invention, as claimed, but is merely representative of presently preferred embodiments.

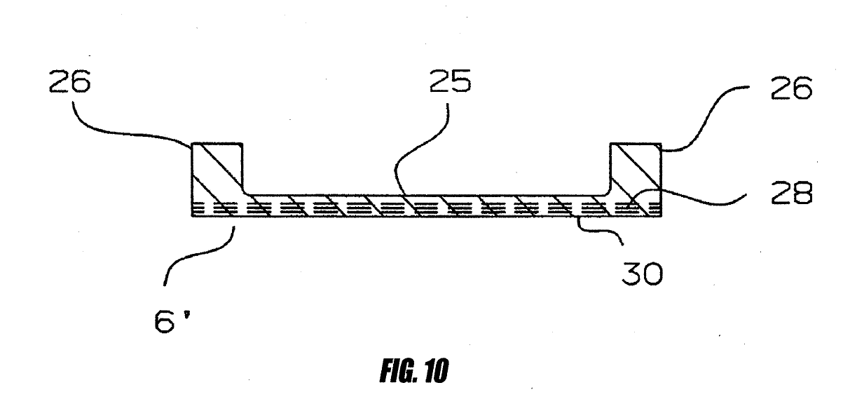

FIG. 13 is an elevated side view of an embodiment of a continuous forming apparatus 100. The continuous forming apparatus 100 receives foaming material from a feeder machine 102 in an input end 104, such as an extrusion machine or other feeding machine known in the art, for delivering foaming materials to the continuous forming apparatus 100 by pouring, dropping, extruding, spreading, or spraying foaming material onto or into the continuous forming apparatus 100. Once the foaming material cures and moves through the molding section 105, it exits the continuous forming apparatus 100 as a foam product from the output end 106 of the continuous forming apparatus 100.

Foaming materials may include but are not limited to thermoplastic and thermoset plastic compounds, highly-filled plastic compounds, composite materials, elastomers, ceramic materials, and cementitious materials that may be mixed with a foaming agent known in the art.

The continuous forming apparatus 100 may include a support structure 108 that supports and positions the components of the continuous forming apparatus 100 and a drive mechanism 110 for imparting motion to various components of the continuous forming apparatus 100. The drive mechanism 110 may generally include a motor and gears for providing the various components of the continuous forming apparatus 100 with the correct force and speed needed for the efficient operation of the continuous forming apparatus 100.

As shown, the continuous forming apparatus 100 has a longitudinal direction 112 and a transverse direction 114.

The continuous forming apparatus 100 may also include a first endless belt 120 and a second endless belt 122 that is opposed to the first endless belt 120. Together, the first endless belt 120 and the second endless belt 122 define a mold cavity for defining the outside dimensions of a foam product. In other words, the first endless belt 120 and the second endless belt 122 contain and provide the foaming material with a final shape as it moves from the input end 104 to the output end 106 of the continuous forming apparatus 100. Of course, the first endless belt 120 and the second endless belt 122 may be covered with mold release to prevent the foaming material from sticking to the endless belts 120, 122.

The continuous forming apparatus 100 may also include a first plurality of cleats 124 and a second plurality of cleats 126 opposed to the first plurality of cleats 124. The first plurality of cleats 124 and the second plurality of cleats 126 engage and support the first endless belt 120 and the second endless belt 122 respectively in molding the foaming material into a foam product. The first plurality of cleats 124 and the second plurality of cleats 126 also prevent the first endless belt 120 and the second endless belt 122 from deforming from the pressure exerted by the foaming material within the mold cavity.

The first plurality of cleats 124, the second plurality of cleats 126, the first endless belt 120, and the second endless belt 122 may be driven or pulled by the drive mechanism 110 at the same speed or at different speeds to move foaming material from the input end 104 to the output end 106 of the continuous forming apparatus 100. Alternatively, the first endless belt 120 and the second endless belt 122 may be un-powered or idle and driven by the first plurality of cleats 124 and the second plurality of cleats 126. Of course, moving the first plurality of cleats 124, the second plurality of cleats 126, the first endless belt 120, and the second endless belt 122 at the same speed helps to prevent damage to the first endless belt 120 and the second endless belt 122 or the foam product held by the first endless belt 120 and the second endless belt 122. By having the pluralities of cleats 124, 126, move with the endless belts 120, 122, friction is reduced in the continuous forming apparatus 100 so that the continuous forming apparatus 100 may use longer and wider endless belts than previously possible.

The first plurality of cleats 124 may be attached together by a first attachment chain 128 to form an endless loop so that the first plurality of cleats 124 may be positioned to continuously provide support to the first endless belt 120 as it molds foaming material. Similarly, the second plurality of cleats 126 may be attached together by a second attachment chain 130 to form an endless loop so that the second plurality of cleats 126 may be positioned to continuously provide support to the second endless belt 122 as it molds foaming material.

The first attachment chain 128 and the second attachment chain 130 hold each cleat of the first plurality of cleats 124 and the second plurality of cleats 126, respectively, spaced at a desired distance to provide support to the first endless belt 120 and the second endless belt 122 without binding up against each other. When the first plurality of cleats 124 and the second plurality of cleats 126 engage the first endless belt 120 and the second endless belt 122, the first attachment chain 128 and the second attachment chain 130 space the cleats of the first plurality of cleats 124 and the second plurality of cleats 126 so that the longitudinal gap between each cleat is kept to a minimum to provide a relatively continuous support surface. Generally, the longitudinal gap may be about 0.1 inches, though the longitudinal gap may be smaller or larger than this depending on the foaming pressures of the foaming material and the strength of the first endless belt 120 and the second endless belt 122 to span the longitudinal gap without deformation or opening of the mold cavity.

The continuous forming apparatus 100 may include a first frame 132 and a second frame 134 that may be attached to the support structure 108. The first frame 132 and the second frame 134 may include rigid slide rails or similar features that engage the first plurality of cleats 124 and the second plurality of cleats 126. The first frame 132 and the second frame 134 help to position the first plurality of cleats 124 and the second plurality of cleats 126 to support and engage the first endless belt 120 and the second endless belt 122. Additionally, the first frame 132 and the second frame 134 help to close the first plurality of cleats 124 with the second plurality of cleats 126 about the first endless belt 120 and the second endless belt 122.

More specifically, compressive loads from the foaming material may press the first endless belt 120 and the second endless belt 122 into the first plurality of cleats 124 and the second plurality of cleats 126, respectively. The normal loads that would tend to separate the opposing first plurality of cleats 124 and the second plurality of cleats 126 are reacted through the first attachment chain 128 and the second attachment chain 130 to the first frame 132 and the second frame 134. To minimize friction, the first attachment chain 128 and the second attachment chain 130 may include rolling elements that contact the first frame 132 and the second frame 134.

The first attachment chain 128 and the second attachment chain 130 also provide a structure strong enough to permit the drive mechanism 110 to move the first plurality of cleats 124, the second plurality of cleats 126, the first endless belt 120, and the second endless belt 122 from the input end 104 to the output end 106 of the continuous forming machine 100. In some configurations, positive drive engagement is provided by the use of sprockets in the drive mechanism 110 that engage and move the chain links.

A speed-controlled motor may be mechanically linked to a sprocket in the drive mechanism 110 to drive the continuous forming apparatus 100. Furthermore, a single motor may be mechanically linked to one or more of the first plurality of cleats 124, the second plurality of cleats 126, the first endless belt 120, and the second endless belt 122. Alternatively, the drive mechanism 110 may include separate motors that are electronically linked that permit the motors to operate at a similar speed to drive two or more of the first plurality of cleats 124, the second plurality of cleats 126, the first endless belt 120, and the second endless belt 122.

The continuous forming apparatus 100 may further include pulleys or sprockets 136 for positioning the first plurality of cleats 124, the second plurality of cleats 126, the first endless belt 120, and the second endless belt 122 relative to each other and the first frame 132 and the second frame 134. Additionally, once a cleat of the plurality of cleats 124, 126 or a portion of one of the endless belts 120, 122 reach the output end 106 of the continuous forming apparatus 100, the cleat or portion rounds a respective pulley or sprocket 136 and returns outside of the molding section 105 to the input end 104 of the continuous forming apparatus 100. At the input end 104 of the continuous forming apparatus 100 new forming material is picked up by the first endless belt 120 and the second endless belt 122, the first plurality of cleats 124 and the second plurality of cleats 126 engage and support the first endless belt 120 and the second endless belt 122, and the foaming material is transported through the molding section 105.

FIG. 14 is a cross sectional view of the continuous forming apparatus 100 of FIG. 13 along line 2-2. In conjunction with FIG. 13, the continuous forming apparatus 100 has a transverse direction 114 and a lateral direction 138.

As shown, the first endless belt 120 and the second endless belt 122 cooperate to form a mold cavity 140, in which foaming material 142 is being molded to have a generally rectangular profile. The first endless belt 120 and the second endless belt 122 may be mirrors of each other so that the first endless belt 120 and the second endless belt 122 each define half of the mold cavity 140.

The first endless belt 120 and the second endless belt 122 may each have a three dimensional molding surface 144 that may be made of an elastomeric material 146 and may comprise fiber reinforcement 148. The elastomeric material 146 is flexible to permit the first endless belt 120 and the second endless belt 122 to bend around the pulleys 136 of FIG. 13. The elastomeric material 146 may include a filler material to improve its thermal conductivity.

The first endless belt 120 and the second endless belt 122 may include sidewalls 150. As the first endless belt 120 and the second endless belt 122 are brought together, the sidewalls 150 abut each other to seal the mold cavity 140 closed and prevent the foaming material 142 from leaking from the mold cavity 140.

The fiber reinforcement 148 provides the first endless belt 120 and the second endless belt 122 with enough longitudinal strength to resist breakage due to the stresses imparted during the molding process, moving over the pulleys, and engaging the first plurality of cleats 124 and the second plurality of cleats 126. The fibers may include cotton, aramid, polyester, nylon, carbon fiber, and may include metal threads. Furthermore, the fibers may provide other benefits to the first endless belt 120 and the second endless belt 122 such as improved thermal conductivity.

Improving the thermal conductivity of the first endless belt 120 and the second endless belt 122 may improve its useful life by preventing thermal degradation of the elastomeric material 146 over time. Additionally, cooling the first endless belt 120 and the second endless belt 122 as they return to the input end 104 shown in FIG. 13 may also improve the useful life of the first endless belt 120 and the second endless belt 122.

In some applications, the first endless belt 120 and the second endless belt 122 may be heated to improve the molding of some foaming materials 142. For example, a thermoset foaming material 142 may cure faster with heat so that by heating the first endless belt 120 and the second endless belt 122 a faster production rate may be achieved. Additionally, thermoplastic foaming material 142 may cool too quickly upon contacting the first endless belt 120 and the second endless belt 122, which may result in an undesirable surface finish such as sharkskin. Heating of the first endless belt 120 and the second endless belt 122 may be provided by warm air or by radiant heat sources known in the art, such as heat lamps.

To help prevent the first endless belt 120 and the second endless belt 122 from deforming under the pressure exerted by the foaming material 142 as they move through the molding section 105, the first plurality of cleats 124 and the second plurality of cleats 126 each respectively engage and support the first endless belt 120 and the second endless belt 122. The first plurality of cleats 124 and the second plurality of cleats 126 may each include a three dimensional abutment surface 152. As the first endless belt 120 and the second endless belt 122 engage the first plurality of cleats 124 and the second plurality of cleats 126, the first endless belt 120 and the second endless belt 122 are pressed into and fully supported by the three dimensional abutment surfaces 152.

A transverse gap 154 may exist between the first plurality of cleats 124 and the second plurality of cleats 126 to prevent the first plurality of cleats 124 and the second plurality of cleats 126 from binding together and to assure that the first endless belt 120 and the second endless belt 122 are closed tightly together. The gap 154 may be about 0.1 inches, but may be larger or smaller depending on the adjustments to the continuous forming apparatus 100.

The first plurality of cleats 124 and the second plurality of cleats 126 may be made of a rigid material such as metal, rubber, ceramic, plastic, or a composite material. Each cleat of the first plurality of cleats 124 and the second plurality of cleats 126 may be made by machining, casting, extrusion, molding, or any other material forming process known in the art.

Each cleat of the first plurality of cleats 124 may be connected together by the first attachment chain 128. Additionally, each cleat of the second plurality of cleats 126 may be connected together by the second attachment chain 130.

The first attachment chain 128 and second attachment chain 130 may include support rollers 156 that engage rails 158 of the first frame 132 and the second frame 134. The rollers 156 and the rails 158 minimize the friction between the moving first plurality of cleats 124 and the moving second plurality of cleats 126 and the stationary first frame 132 and second frame 134. The rails 158 also align the first plurality of cleats 124 with the second plurality of cleats 126. Furthermore, the rails 158 prevent lateral motion of the first plurality of cleats 124 and the second plurality of cleats 126, which may damage a foam product or inadvertently open the mold cavity 140.

FIG. 14 also shows the first plurality of cleats 124, the second plurality of cleats 126, the first endless belt 120, and the second endless belt 122 returning to the input end 104 of the continuous forming machine and positioned outside of the molding section 105.

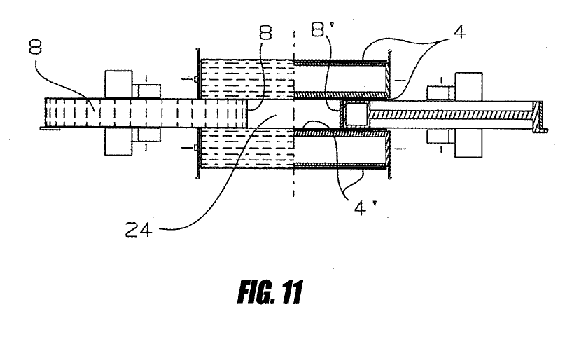

Referring to FIG. 15, an exploded cross sectional view of FIG. 13 taken along line 2-2 illustrates an alternative first endless belt 170, a second endless belt 172, and a first plurality of cleats 174, a second plurality of cleats 176 that may be used with the continuous forming apparatus 100. As shown, the first endless belt 170 includes a three dimensional molding surface 178 that may include curves and may be used to produce crown molding or other foam product. The first endless belt 170 also includes sidewalls 150 for engaging and sealing against the second endless belt 172.

The first endless belt 170 and the second endless belt 172 may be made of an elastomeric material 146 that permits the first endless belt 170 and the second endless belt 172 to round the pulleys 136 of FIG. 13 without cracking and breaking. The first endless belt 170 and the second endless belt 172 may also includes fiber reinforcement 148 for providing the longitudinal strength that permits the first endless belt 170 and the second endless belt 172 to experience the longitudinal stresses of being pulled around the continuous forming apparatus 100.

The second endless belt 172 may include a flat molding surface 180 that closes a mold cavity 182 formed by the first endless belt 170. In this configuration, the mold features are mostly determined by the first endless belt 170 which may provide some cost savings to manufacturers by requiring a change of only the first endless belt 170 to change the profile of the mold cavity 182.

The first plurality of cleats 174 may include a three-dimensional abutment surface 184 that engages and supports the first endless belt 170 against the second endless belt 172. The second plurality of cleats 176 may include a flat abutment surface 186 that engages and supports the second endless belt 172 against the first endless belt 170.

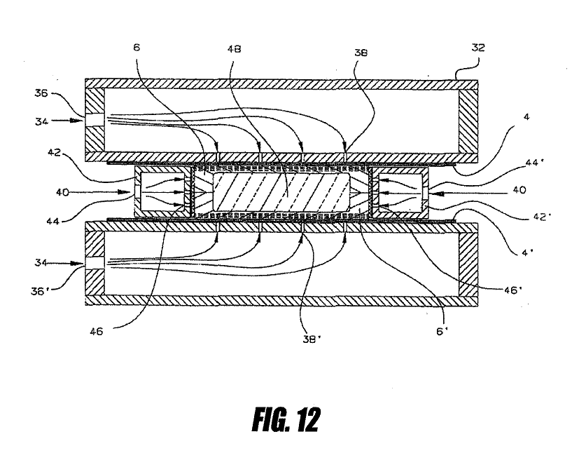

FIG. 16 is a top view of FIG. 15 along line 4-4 that illustrates the first endless belt 170 and the first plurality of cleats 174. As shown, the first plurality of cleats 174 has engaged and is supporting the first endless belt 170.

The cleats of the first plurality of cleats 174 may be spaced from each other by a longitudinal gap 190. The longitudinal gap 190 may range from about an inch or more to almost abutting an adjacent cleat, but may preferably be about 0.1 inches which may be large enough to prevent the first plurality of cleats 174 from binding together as they move over the continuous forming apparatus. Additionally, the gap 190 may be small enough that the first endless belt 170 does not deform in the gap 190 sufficiently to significantly affect the profile of the mold cavity 182.

As shown, the first endless belt 170 includes discrete mold cavities 182 that are separated by a mold wall 192 of the first endless belt 170. The mold wall 192 separates the discrete mold cavities 182 and may assist in removing a foam product from a mold cavity 192.

FIG. 17 is an elevated side view of another embodiment of a continuous forming apparatus 200. As shown, the continuous forming apparatus 200 is similar to the continuous forming apparatus 100 of FIG. 13 but includes a single endless belt 202 that is engaged and supported by a first plurality of cleats 204 and a second plurality of cleats 206. Furthermore, the continuous forming apparatus 200 may also include positioning rollers 208 that help form the endless belt 202 so that it may engage and be supported by both the first plurality of cleats 204 and a second plurality of cleats 206.

A foam product 207 is also shown exiting the output end 106 of the continuous forming apparatus 200.

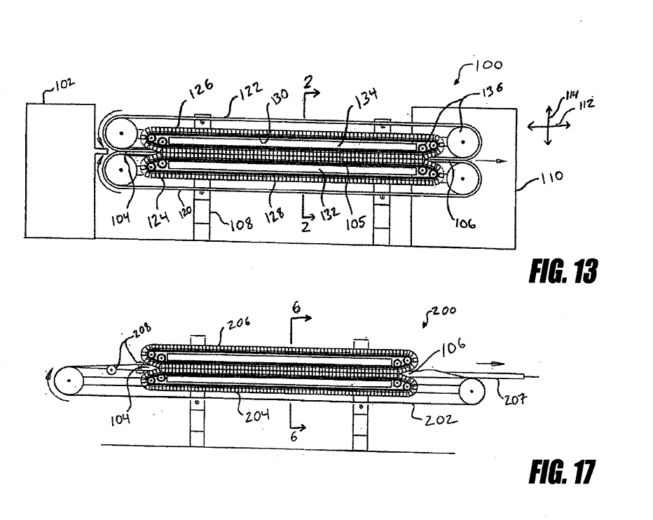

FIG. 18 is a cross sectional view of the continuous forming apparatus 200 of FIG. 17 along line 6-6 that further illustrates how the endless belt 202 engages and may be supported by both the first plurality of cleats 204 and the second plurality of cleats 206. Specifically, the endless belt 202 has a flat molding surface 208 and a length 210 that is sufficient to permit the endless belt 202 to be rolled into a circular configuration where a first side edge 212 of the endless belt 202 contacts and seals against a second side edge 214 of the endless belt 202. Of course, other cross sectional shapes besides circles may be formed, such as ovals and polygons.

When the endless belt 202 engages the first plurality of cleats 204 and the second plurality of cleats 206, the first side edge 212 and the second side edge 214 are positioned away from the transverse gap 154 and adjacent to one of the curved three dimensional abutment surfaces 216 of the first plurality of cleats 204 and the second plurality of cleats 206. The curved three dimensional abutment surfaces 216 provide support to the endless belt 202 in both lateral direction 138 and the transverse direction 114. Similarly, the endless belt 202 supports a foaming material 218 in both lateral direction 138 and the transverse direction 114.

Once the foaming material 218 is molded into the foam product 207 shown in FIG. 17, the endless belt 202 may be flattened and returned to the input end 104 of the continuous forming apparatus 200 of FIG. 17 where it is re-rolled and reengages the first plurality of cleats 204 and the second plurality of cleats 206.

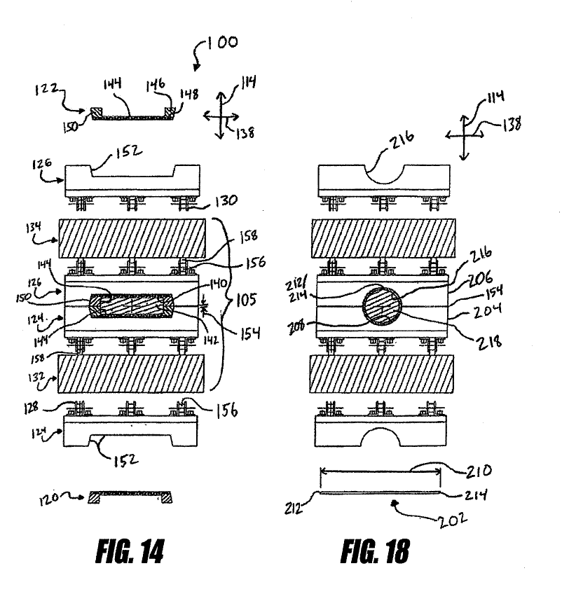

FIG. 19 is an elevated side view and FIG. 20 is a top view of an alternative embodiment of a continuous forming apparatus 250. As shown in FIGS. 7 and 8, the continuous forming apparatus 250 is similar to the continuous forming apparatus 100 of FIG. 13 and includes a first endless belt 252, a second endless belt 254, a first plurality of cleats 256, and a second plurality of cleats 258.

However, the continuous forming apparatus 250 may also include a third endless belt 260 and a fourth endless belt 262 that is opposed to the third endless belt 260. The third endless belt 260 and the fourth endless belt 262 may be disposed substantially orthogonal to the first endless belt 252 and a second endless belt 254.

Additionally, the continuous forming apparatus 250 may also include a mold release application device 264. The mold release application device 264 may mist, spray, brush, or in any other manner known in the art apply a mold release agent to the first endless belt 252, the second endless belt 254, the third endless belt 260, and the fourth endless belt 262.

Furthermore, the continuous forming apparatus 250 may include a temperature control system 266. The temperature control system 266 may be used to preheat the first endless belt 252, the second endless belt 254, the third endless belt 260, and the fourth endless belt 262 in preparation for molding foaming material with the continuous forming apparatus 250. The temperature control system 266 may also be used to control the temperature of the first endless belt 252, the second endless belt 254, the third endless belt 260, and the fourth endless belt 262 while the continuous forming apparatus 250 is in operation.

The temperature control system 266 may include heated air, heat lamps, or other sources of radiant energy for heating the first endless belt 252, the second endless belt 254, the third endless belt 260, and the fourth endless belt 262. Additionally, the temperature control system 266 may include fans, air conditioners, and evaporative coolers for providing cool air flow to cool the first endless belt 252, the second endless belt 254, the third endless belt 260, and the fourth endless belt 262. The temperature control system 266 may also include nozzles for spraying or misting a coolant, such as water, onto the first endless belt 252, the second endless belt 254, the third endless belt 260, and the fourth endless belt 262.

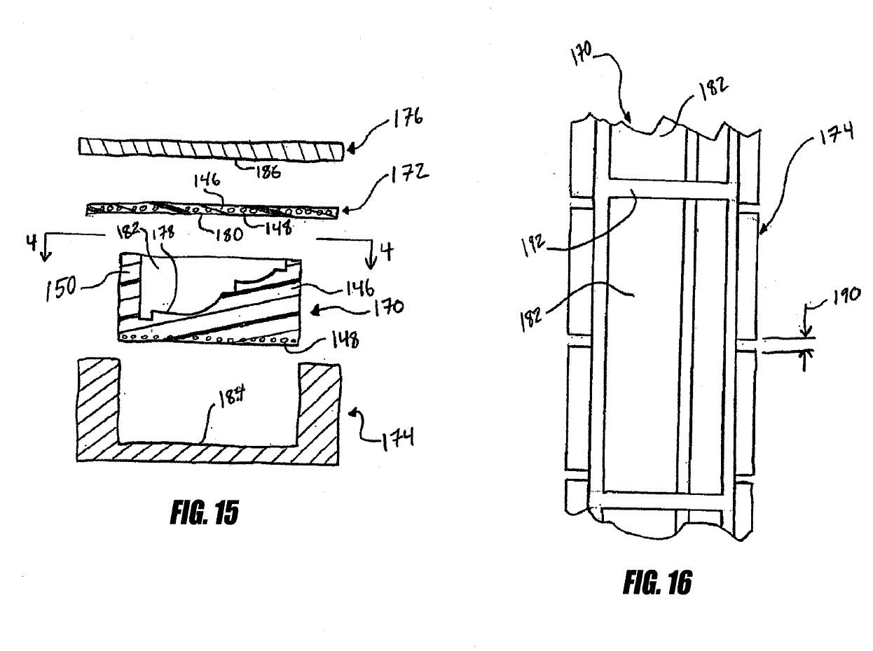

FIG. 21 is a cross sectional view of the continuous forming apparatus 250 of FIG. 19 along line 9-9. As shown, the first endless belt 252, the second endless belt 254, the third endless belt 260, and the fourth endless belt 262 cooperate to define a mold cavity 270 for molding the foaming material 272. The first endless belt 252, the second endless belt 254, the third endless belt 260, and the fourth endless belt 262 include flat molding surfaces 274 used to support the foaming material 272 on one side.

By using four endless belts 252, 254, 260, and 262, the thickness of the endless belts 252, 254, 260, and 262 is kept to a minimum which reduces the stress that the endless belts 252, 254, 260, and 262 undergo as they wrap around the pulleys of the continuous forming apparatus 250. By reducing the stresses on the endless belts 252, 254, 260, and 262, the useful life of the endless belts 252, 254, 260, and 262 may be extended. Additionally, the endless belts 252, 254, 260, and 262 may be made of other materials than elastomers, such as metals, polymers, composites, and fabrics. Furthermore, by using four endless belts 252, 254, 260, and 262, larger profiles of the mold cavity 270 are possible than using two endless belts incorporating sidewalls.

The first plurality of cleats 256 and the second plurality of cleats 258 each include a three dimensional abutment surface 278 for abutting and supporting the first endless belt 252, the second endless belt 254, the third endless belt 260, and the fourth endless belt 262. As shown, the first plurality of cleats 256 and the second plurality of cleats 258 mirror and oppose each other in supporting the mold cavity 270. Because the first plurality of cleats 256 and the second plurality of cleats 258 include a three dimensional abutment surface 278, the first plurality of cleats 256 and the second plurality of cleats 258 are able to provide support in the lateral 138 and transverse 114 directions.

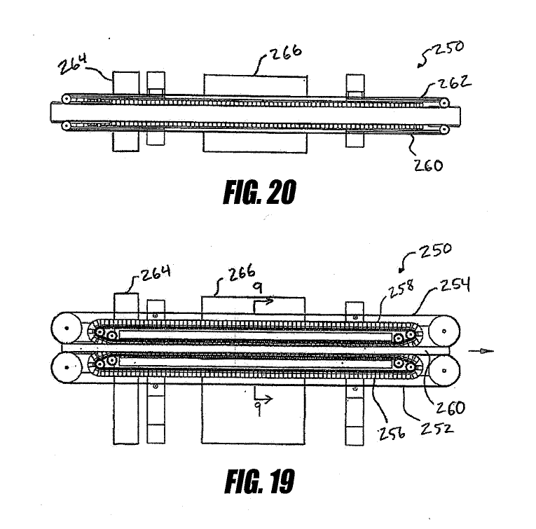

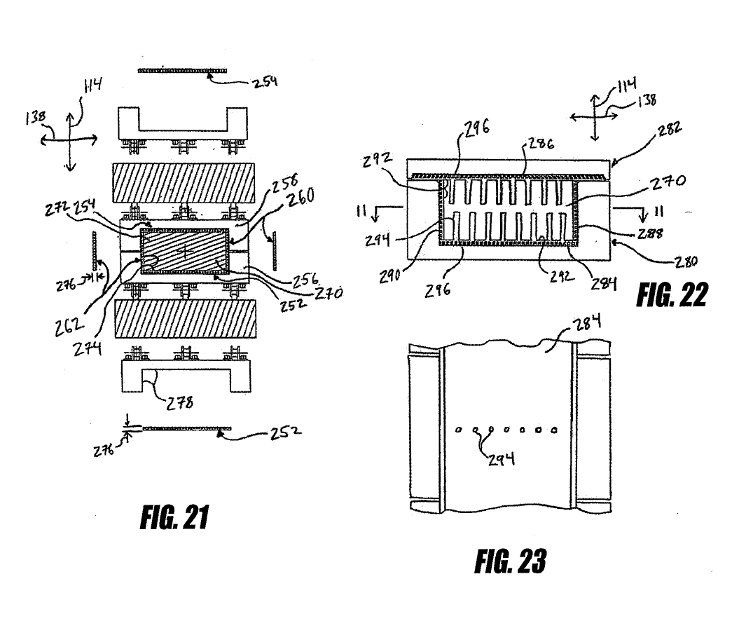

FIG. 22 is an alternative cross sectional view taken along line 9-9 of FIG. 19 illustrating a first plurality of cleats 280, a second plurality of cleats 282, a first endless belt 284, a second endless belt 286, a third endless belt 288, and a fourth endless belt 290 that may be used with the continuous forming apparatus 250. As shown, the first endless belt 284, the second endless belt 286, the third endless belt 288, and the fourth endless belt 290 may include flat molding surfaces 292. The first endless belt 284 and the second endless belt 286 may also include separation features 294 for facilitating the separation of a foam product into discrete foam products.

Additionally, the first plurality of cleats 280 and a second plurality of cleats 282 include three dimensional abutment surfaces 296. The three dimensional abutment surfaces 296 permit the first plurality of cleats 280 to contact and support the first endless belt 284, the third endless belt 288, and the fourth endless belt 290, while the second plurality of cleats 282 contacts and supports the second endless belt 286 in the lateral 138 and transverse 114 directions.

In this configuration, the first plurality of cleats 280 defines a majority of the mold cavity 270. Thus, only the first plurality of cleats 280 may need to be changed in order to change the profile of the mold cavity 270.

FIG. 23 is a cross sectional view of FIG. 22 along line 11-11 and illustrates the positioning of the separation features 294 on the first endless belt 284. The separation features 294 form holes in a foam product which weakens the foam product at the location of the separation features 294, permitting the foam product to be selectively broken at the separation features 294.

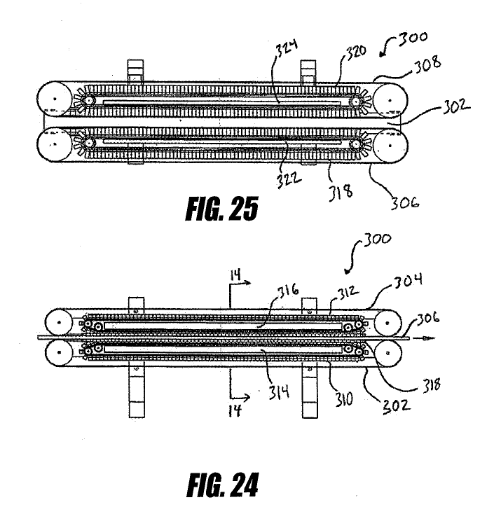

FIG. 24 is an elevated side view of an alternative embodiment of a continuous forming apparatus 300. As shown, the continuous forming apparatus 300 is similar to the continuous forming apparatus 250 of FIGS. 7 and 8 and includes a first endless belt 302, a second endless belt 304, a third endless belt 306, a fourth endless belt 308 (shown in FIG. 25), a first plurality of cleats 310, a second plurality of cleats 312, a first frame 314, and a second frame 316. The continuous forming apparatus 300 may also include a third plurality of cleats 318 and a fourth plurality of cleats 320 (shown in FIG. 25).

FIG. 25 is a top view of the continuous forming apparatus 300 of FIG. 24 with the second endless belt 304 and second plurality of cleats 312 removed to more clearly show the third plurality of cleats 318 and the fourth plurality of cleats 320. The continuous forming apparatus 300 may also include a third frame 322 and a fourth frame 324 for respectively supporting the third plurality of cleats 318 and the fourth plurality of cleats 320 in molding a foaming material.

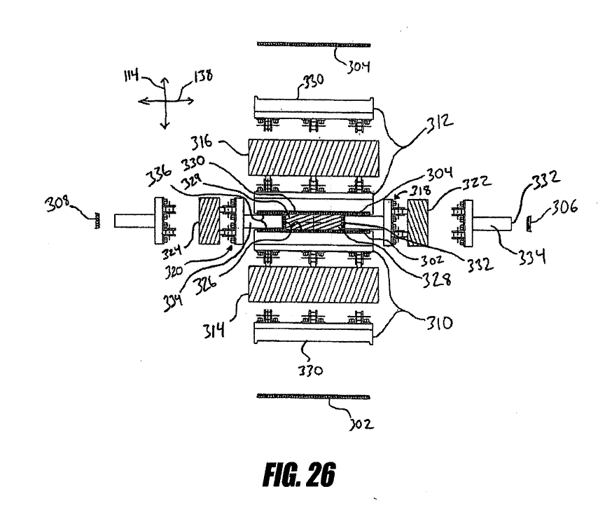

FIG. 26 is a cross sectional view along line 14-14 of the continuous forming apparatus 300 of FIG. 24. As shown, the first endless belt 302, the second endless belt 304, the third endless belt 306, and the fourth endless belt 308 include flat molding surfaces 326 used to define a mold cavity 328 and mold the foaming material 329. As the endless belts 302, 304, 306, 308 are brought together to form the mold cavity 328, the third endless belt 306 and the fourth endless belt 308 are slightly compressed edgewise by the first endless belt 302 and the second endless belt 304 to create a seal between endless belts 302, 304, 306, 308 and thereby prevent the escape of expanding foaming material 329.

The first plurality of cleats 310 and the second plurality of cleats 312 may include a three dimensional abutment surface 330. The abutment surfaces 330 of the first plurality of cleats 310 contacts and the second plurality of cleats 312 provides support to the first endless belt 302 and the second endless belt 304 in the lateral 138 and transverse 114 directions.

The third plurality of cleats 318 and the fourth plurality of cleats 320 may both include a flat abutment surface 332 and a neck 334 that disposes to engage and support the third endless belt 306 and the fourth endless belt 308 respectively. The neck 334 is narrow so that it may extend between the first endless belt 302 and the second endless belt 304 while providing transverse gaps 336 between the neck and the first endless belt 302 and the second endless belt 304. The transverse gaps 336 help to prevent the third plurality of cleats 318 and the fourth plurality of cleats 320 from binding with the first endless belt 302 and the second endless belt 304.

This configuration may be used to produce large profiled foam product or products that require relatively long processing lengths. An added advantage of this configuration is that the distance between the third endless belt 306, the fourth endless belt 308, the third plurality of cleats 318, the fourth plurality of cleats 320, the third frame 322, and the fourth frame 324 may be adjusted, which allows the same equipment to produce profiles of common depth but varying widths. For example, if synthetic lumber were being produced, the same continuous forming apparatus may be used to produce synthetic lumber in 2×2, 2×4, 2×6, 2×8, 2×10 sizes with relatively minor adjustments to the continuous forming apparatus.

Each plurality of cleats 310, 312, 318, 320 may be moved or driven at the same speed. The third plurality of cleats 318 and fourth plurality of cleats 320 may be unpowered and idle, relying on the first plurality of cleats 310 and the second plurality of cleats 312 and mold friction to drag them along at the needed speed.

FIG. 27 is an elevated side view of another embodiment of a continuous forming apparatus 400. As shown, the continuous forming apparatus 400 is similar to the continuous forming apparatus 100 of FIG. 13 and includes a first endless belt 402, a second endless belt 404, a first plurality of cleats 406, a second plurality of cleats 408, a first frame 410, and a second frame 412. However, the first endless belt 402, the first plurality of cleats 406 and the first frame 410 are longer than the second endless belt 404, the second plurality of cleats 408, and the second frame 412. Additionally, the continuous forming apparatus 400 includes an insert placing means 414.

The difference in length between the first endless belt 402 and the second endless belt 404 permits the insert placing means 414 to place inserts on the first endless belt 402. Before the first endless belt 402 engages the second endless belt 404, the inserts are disposed within a closed mold cavity of the continuous forming apparatus 400. Inserts may include electrical wiring, threaded connectors, reinforcements, fasteners, and other items known in the art that may be molded into a product. The insert placing means 414 may be a person placing inserts by hand or an automated machine.

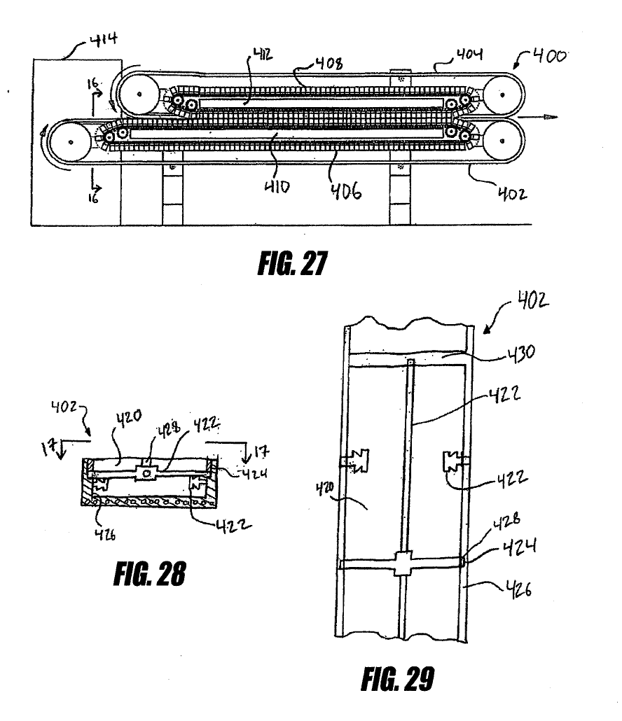

FIG. 28 is a cross sectional view of the first endless mold belt 402 of forming apparatus 400 of FIG. 27 along line 16-16 that illustrates the first endless belt 402 as including a mold cavity 420. As shown, inserts 422 disposed within a mold cavity of the first endless belt 402. Additionally, slots 424 may be positioned in the wall 426 of the first endless belt 402 in order to support and position the inserts 422 within the mold cavity 420. Mold slot covers 428 may be used to prevent foaming material from contacting portions of the inserts 422 that extend into the slots 424 and are to extend from the finished foam product.

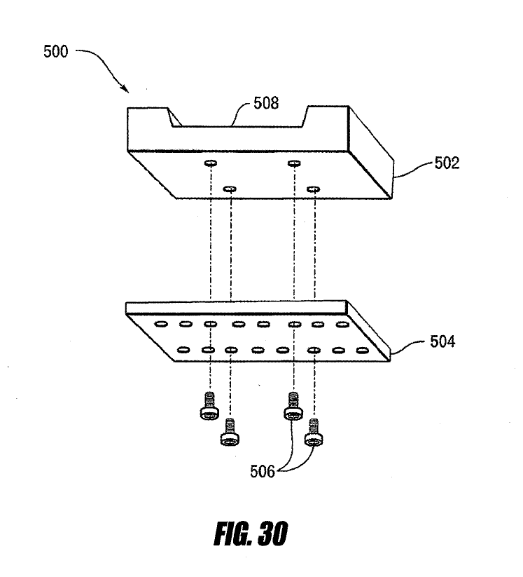

FIG. 29 is a top view of the cross sectional view of FIG. 28 along line 17-17. As shown, inserts 422 are disposed within the mold cavity 420 of the first endless belt 402. The inserts 422 extend into the slots 424 in the wall 426. The slots 424 are filled by the mold slot covers 428. Additionally, the first endless belt 402 includes a mold wall 430 for separating the first endless belt 402 into discrete mold cavities 420 for making discrete products.

FIG. 30 is an exploded view of an embodiment of a cleat 500. The cleat 500 may include a mold support portion 502, a base portion 504, and an attachment mechanism 506. The mold support portion 502 includes an abutment surface 508 for engaging and supporting an endless belt.

The base portion 504 is removably attachable to the mold support portion 502 by the attachment mechanism 506. This permits the mold support portion 502 to be quickly and efficiently changed while leaving the base portion 504 attached to an attachment chain. Thus, a mold support portion 502 having a curved abutment surface 508 may be changed to an abutment surface 508 having flat surfaces and corners.

The attachment mechanism 506 may include threaded fasteners, clips, tongue and groove features, or other mechanical fasteners known in the art. Of course, the base portion 504 and the mold support portion 502 may be integrally formed or welded together so that the attachment mechanism 506 is no longer needed.

In conclusion, various configurations of a continuous forming apparatus have been disclosed. A continuous forming apparatus may be used in the production of a variety of foam products including, but not limited to synthetic lumber, roofing, siding, interior molding & trim, panels, fencing, doors, window blind slats, etc. Furthermore, a continuous forming apparatus may be used to process foam thermoplastics, foam thermoset plastics, foam ceramic or concrete materials, foam ceramic/plastic blends, and composites.

Generally, a continuous forming apparatus may include one or more endless belts and a plurality of cleats for supporting the endless belts and reducing the friction that results from operating the continuous forming apparatus. The endless belts help to define a product's shape and texture. Additionally, the endless belts may incorporate localized features, such as pockets, ridges, knobs, clips, brackets, etc., in the mold belt cavity may be used to locate and hold inserts in position that will be cast or molded into the product. The inserts may be embedded into the product for reinforcement, thread attachment, handles, hard points, wear plates, internal conduit or plumbing, electrical wiring, or any such characteristic that might enhance product performance or eliminate subsequent assembly.

Conventional laminated conveyor belts may be used as endless belts. Endless belts requiring greater thickness may be fabricated by casting a rubber mold face onto an existing belt or fabric-reinforced carcass. Thicker endless belts may also have the mold surface or product-molding cavity machined or otherwise carved into the belt face. Release films or layers at the outer surfaces of the belts may also be incorporated into mold belts to facilitate release from the formed product.

The cleats used in the continuous forming apparatus may be made of nearly any rigid or semi-rigid material such as metal, plastic, rubber, composite, ceramic, or a combination thereof. The cleats may incorporate a base that stays attached to the chain and an easily removable cleat profile to facilitate changes in profile and product size. The cleat profiles may include a radius, angle, or other feature on its abutment surface to allow an endless belt to easily center itself within the cleat. For example, the cleats 124, 126 and endless belts 120, 122 shown in FIG. 14 share angled sides that are wider at the opening to help the endless belts 120, 122 center and nest themselves into the cleats 124, 126. Additionally, the profiles of opposed cleats may vary greatly depending on the shape of the product and how the manufacturer prefers to divide the overall cavity. Furthermore, the cleats may be machined, molded, cast, extruded, or a combination thereof out of metal, plastic, rubber, composite, ceramic, or a combination of materials.

The use of high-strength chains and sprockets allow considerable pulling force to be used in driving the continuous forming apparatus in the direction of production. Furthermore, the rolling elements of the attachment chains contacting the rigid rails of the frames minimize friction within the continuous forming apparatus and allow longer and wider belts to be driven and larger products processed. Additionally, the length of a continuous forming apparatus should be long enough, and/or speed of the endless belts and pluralities of cleats slow enough, to assure that the foaming material is sufficiently cooled and/or cured to maintain the desired shape of the foam product when exiting the continuous forming apparatus.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

The polyurethane composite material of some embodiments may exert certain pressures on the walls of any mold, such as that found in the forming devices as described above. While the amount of pressure may vary according to the amount of foaming and gas production, it is preferred that such forming devices may exert or hold pressures by the mold cavity ranging from about 35 to about 75 psi. In some embodiments, the pressure is from about 45 to about 65 psi. In some embodiments, the pressure is about 50 psi. However, mold pressures in any embodiment of a method of making the polyurethane composite material can be higher than or less than the specified values. The exact pressure required in the formation of the desired shaped article depends on the density, color, size, shape, physical properties, and the mechanical properties of the article comprising the polyurethane composite material.

When foaming polyurethane is formed by belts into a product shape, the pressure that the belts exert on the foamed part is related to the resulting mechanical properties. For example, as the pressure of the foaming increases and the belt system can hold this pressure without the belts separating, then the product may have higher flexural strength, then if the belts allowed leaking, or pressure drop. In some embodiments, pressures about 50 to about 75 psi have been used to obtain high mechanical properties in the polyurethane composite material. In one example, an increase in the flexural strength of 50 psi results from the higher pressure in the belts, versus using a lower pressure.

In some embodiments, a shaped article comprising the polyurethane composite material as described herein is roofing material such as roof tile shingles, etc., siding material, carpet backing, synthetic lumber, building panels, scaffolding, cast molded products, decking materials, fencing materials, marine lumber, doors, door parts, moldings, sills, stone, masonry, brick products, post, signs, guard rails, retaining walls, park benches, tables, slats and railroad ties.

Other shaped articles may comprise a portion of which comprises the polyurethane composite material. In some embodiments, the polyurethane composite material is coated or molded on one side of an article. For example, the polyurethane composite material may be coated or molded onto one side of a flat or S-shaped clay roof tile, which has been cut or molded thinner than normal, and laid on a conveyor belt, followed by extrusion of the polyurethane composite material onto at least a portion of the tile. Such portion may be shaped by a mold which is adapted to shape the polyurethane composite material deposited on the tile. For example, the forming unit may operate with two mold belts which are adapted to shape the polyurethane composite material on one side of the portion. In some embodiments, the composite material may provide backing to an article. In some embodiments, the composite material may be foamed sufficient to provide insulation to an article.

In some embodiments, the polyurethane composite material can reinforce an article. For example, by placing a coating or molding of the polyurethane composite material on a roof tile, the impact strength of the roof tile is increased. Thus some embodiments comprises a method of substantially reducing the fracture of an article by depositing the polyurethane composite on a solid surface article, shaping the composite on the solid surface article by methods described herein, and curing the composite on the solid surface article. Such method may produce a one or more of a reinforced, backed, or insulated article. Such article may also have increased physical and mechanical properties. Additionally, a reinforcing layer may be used to prevent water weeping, and increases the overall thickness of a solid surface article.

In some embodiments, the polyurethane composite material can bond directly to an article solid surface article such as a tile. Alternatively, an adhesive can be applied to the solid surface article and a shaped polyurethane composite article can be attached thereto. A solid surface article such as a tile may include at least one or more of cement, slate, granite, marble, and combinations thereof; and the polyurethane composite material as described in embodiments herein. Such tiles may be used as roofing or siding tiles.

In some embodiments, the composite material may be used as reinforcement of composite structural members including building materials such as doors, windows, furniture and cabinets and for well and concrete repair. In some embodiments, the composite material may be used to fill any unintended gaps, particularly to increase the strength of solid surface articles and/or structural components. Structural components may formed from a variety of materials such as wood, plastic, concrete and others, whereas the defect to be repaired or reinforced can appear as cuts, gaps, deep holes, cracks.

### Optional Additional Mixing Process

One of the most difficult problems in forming polyurethane composite materials which have large amounts of filler is getting intimate mixing—blending the polyols and the isocyanate. In some embodiments, an ultrasound device may be used to cause better mixing of the various components of the polyurethane composite material. In these embodiments, the ultrasound mixing may also result in the enhanced mixing and/or wetting of the components. In some embodiments, the enhanced mixing and/or wetting allows a high concentration of filler, such as coal ash to be mixed with the polyurethane matrix, including about 40, 50, 60, 70, 80, and about 85 wt % of the inorganic filler.

In some embodiments, the ultrasound device produces an ultrasound of a certain frequency. In some embodiments, the frequency of the ultrasound device is varied during the mixing and/or extrusion process. In some embodiments, the components are mixed in a continuous mixer, such as an extruder, equipped with an ultrasound device. In some embodiments, an ultrasound device is attached to or is adjacent to the extruder and/or mixer. In other embodiments, an ultrasound device is attached to the die of the extruder. In other embodiments, the ultrasound device is placed in a port of the extruder or mixer. In further embodiments, an ultrasound device provides vibrations at the location where the isocyanate and polyol meet as the screw delivers the polyol to the isocyanate.

In addition, an ultrasound device may provide better mixing for the other components, such as blowing agents, surfactants, catalysts. In embodiments where additional components are added to the polyol prior to mixing the polyol with the isocyanate, the additional components are also exposed to ultrasound vibration. In some embodiments, an ash selected from fly ash, bottom ash, or combinations thereof, is mixed using an ultrasound device. In some embodiments, ultrasound vibrations breaks up filler and fiber bundles to allow more thorough wetting of these components to provide a polyurethane composite material with better mechanical properties, such as flexural modulus and flexural strength, as compared to polyurethane composite materials which are created without the use of ultrasound vibration. The wetting of fibers and fillers could also be increased by the use of ultrasound at or near the die of the extruder, thus forcing resin to coat the fibers and fillers better, and even breaking up fiber bundles and filler lumps. The sound frequency and intensity would be adjusted to give the best mixing, and what frequency is best for the urethane raw materials, may not be best for the filler and fibers. In some embodiments, one or more of the components may be preblended in a mixer, such as a high shear mixer. Unless otherwise noted, all percentages and parts are by weight.

In other embodiments a simple high shear liquid mixer may be used to pre-mix the isocyanate and polyol just before they enter the extruder. In some embodiments, phosphoric acid or other known reactions inhibitors may be added to the polyol prior to the high shear mixing to present premature gelling in highly reactive polyol-isocyanates.

Other compositions and methods that may be used are described in: 1) US 20050163969, incorporated by reference herein in its entirety; 2) US 20050161855, incorporated by reference herein in its entirety; 3) US 20050287238, incorporated by reference herein in its entirety; 4) US 20070225419, incorporated by reference herein in its entirety; and 5) US 20070222105, incorporated by reference herein in its entirety.

The skilled artisan will recognize the interchangeability of various features from different embodiments. Similarly, the various features and steps discussed above, as well as other known equivalents for each such feature or step, can be mixed and matched by one of ordinary skill in this art to perform compositions or methods in accordance with principles described herein. Although the invention has been disclosed in the context of some embodiments and examples, it will be understood by those skilled in the art that the invention extends beyond the specifically disclosed embodiments to other alternative embodiments and/or uses and obvious modifications and equivalents thereof. Accordingly, the invention is not intended to be limited by the specific disclosures of embodiments herein. Rather, the scope of the present invention is to be interpreted with reference to the claims that follow.

What is claimed is:

1. A method of preparing a synthetic building material comprising:
Reacting a mixture comprising:
A diisocyanate or polyisocyanate;
A first polyol having a hydroxyl group number from about 250 mg KOH to about 500 mg KOH;
A second polyol having a hydroxyl group number from about 20 mg KOH to about 240 mg KOH;
Wherein the ratio of the first polyol to the second polyol is about 3 to about 20; and
Wherein the reaction mixture has a viscosity of about 1 cP to about 1500 cP;
Water at a concentration of about 0.02% to about 2% of the weight of the composite material;
Blending a product of the reaction mixture with an inorganic particulate material to provide a substantially uniform mixture;
wherein the filler has a weight that is about 60% to about 85% of the weight of the composite material;
Without heating, forcing the substantially uniform mixture through a hole into a mold; and
Curing the mixture in the mold.

2. The method of claim 1 wherein the density of the synthetic building material is about 30 lb/ft³ to about 80 lb/ft³.

3. The method of claim 1 wherein the inorganic particulate is recycled waste or scrap material.

4. The method of claim 3 wherein the recycled waster or scrap material is coal ash.

5. The method of claim 3 wherein the recycled waster or scrap material is ground glass.

6. The method of claim 1 wherein a surface pattern is imparted onto the synthetic lumber material.

7. A composite material comprising:
a product of a reaction of a mixture comprising:
a diisocyanate or polyisocyanate;
a first polyol having a hydroxyl number from about 250 mg KOH/g to about 500 mgKOH/g; and
a second polyol having a hydroxyl number from about 120 mg KOH/g to about 240 mg KOH/g; and
an inorganic particulate material that is dispersed throughout the product of the reaction mixture, wherein the inorganic particulate material has a weight that is about 60% to about 85% of the weight of the composite material and;
wherein the composite material has a shape provided by a process comprising forcing the inorganic particulate material dispersed in the reaction mixture through a hole.

8. The composite material of claim 7, wherein the reaction mixture further comprises water at a concentration of about 0.02% to about 2% of the weight of the composite material.

9. The composite material of claim 8 wherein the ratio of the first polyol to the second polyol is about 1 to about 20.

10. The composite material of claim 7 wherein the density is about 30 lb/ft³ to about 90 lb/ft³.

11. The composite material of claim 7 wherein the inorganic particulate is fly ash.

12. The composite material of claim 7 wherein the composite material contains fibrous material.

13. A method of preparing a composite polyurethane material comprising:
reacting a mixture comprising:
a diisocyanate or polyisocyanate;
a first polyol having a hydroxyl number greater from about 300 mg KOH/g to about 1000 mg KOH/g;
a second polyol having a hydroxyl number from about 150 mg KOH/g to about 300 mg KOH/g;
blending a product of a reaction of the mixture with an inorganic particulate material to provide a substantially uniform mixture;
without heating, forcing the substantially uniform mixture through a hole into a mold; and
curing the mixture in the mold.

14. The method of claim 13 wherein the ratio of the first polyol to the second polyol is about 1 to about 20.

15. The method of claim 13 wherein the density of the polyurethane composite material is about 30 lb/ft³ to about 60 lb/ft³.

16. The method of claim 13 wherein the viscosity of the first polyol is about 1 cP to about 2000 cP.

17. The method of claim 13 wherein the viscosity of the second polyol is about 1 cP to about 1000 cP.

18. The method of claim 13 wherein the inorganic particulate comprises coal ash.

19. The method of claim 13 wherein the composite material contains a fibrous material.

20. The method of claim 13 wherein water is added to the reacting mixture at a concentration of about 0.02% to about 2% of the weight of the composite material.
